(19) United States
(12) Patent Application Publication
(10) Pub. No.: US 2014/0262002 A1
(43) Pub. Date: Sep. 18, 2014

(54) MICRO-STRUCTURED OPTICALLY CLEAR ADHESIVES

(71) Applicant: 3M INNOVATIVE PROPERTIES COMPANY, St. Paul, MN (US)

(72) Inventors: Toshihiro Suwa, Kanagawa Pref. (JP); Albert I. Everaerts, Oakdale, MN (US); Haruyuki Mikami, Kanagawa Pref. (JP); Yasuhiro Kinoshita, Tokyo (JP)

(73) Assignee: 3M INNOVATIVE PROPERTIES COMPANY, St. Paul, MN (US)

(21) Appl. No.: 14/352,189

(22) PCT Filed: Oct. 24, 2012
(86) PCT No.: PCT/US2012/061528

§ 371 Date: Apr. 16, 2014

Related U.S. Application Data
(60) Provisional application No. 61/550,725, filed on Oct. 24, 2011.

(51) Int. Cl. C09J 7/00; C09J 5/06

(52) U.S. Cl. CPC C09J 7/00; C09J 5/06
USPC 156/249; 428/156; 428/172; 156/60

(57) ABSTRACT

A micro-structured optically clear adhesive, including a first major surface and a second major surface, wherein at least one of the first and second major surfaces comprises a micro-structured surface of interconnected micro-structures in at least one of the planar dimensions (x-y), is disclosed. The micro-structured optically clear adhesive has a tan delta value of at least about 0.3 at a lamination temperature and is non-crosslinked or lightly crosslinked. The micro-structured surface may include indentations having a depth of between about 5 and about 80 microns. A method of laminating a first substrate and a second substrate without the use of a vacuum is provided. The method includes providing a micro-structured optically clear adhesive, removing a release liner from a first side of the micro-structured optically clear adhesive, contacting the first side of the micro-structured optically clear adhesive with a surface of the first substrate, removing a micro-structured release liner from a second side of the micro-structured optically clear adhesive to expose a micro-structured surface, and contacting the micro-structured surface with a surface of the second substrate.

### CROSS REFERENCE TO RELATED APPLICATIONS

This application claims the benefit of U.S. Provisional Application Ser. No. 61/550,725, filed Oct. 24, 2011, the disclosure of which is incorporated by reference herein in its entirety.

### FIELD OF THE INVENTION

The present invention is generally related to the field of optically clear adhesives and methods of lamination using an optically clear adhesive. In particular, the present invention is related to micro-structured optically clear adhesives and methods of vacuumless lamination.

### BACKGROUND

The display surface of an image display device, such as a liquid crystal display (LCD) or an organic EL display, is generally protected with a translucent sheet, such as a glass plate or plastic film. The translucent sheet is fixed to the housing of an image display device, for example, by laminating a tape or coating an adhesive along the edge of the translucent sheet. This procedure creates a gap between the translucent sheet and housing which is typically filled with air. Therefore, an air layer is present between the translucent sheet and the display surface of the image display device. For example, in the case of a liquid crystal image device, because of the difference in refractive indexes between the air layer and the translucent sheet and the difference in refractive indexes between the air layer and the liquid crystal module material, reflection or scattering of light is caused, potentially reducing the luminance or contrast of an image displayed on the image display device and in turn, impairing visibility of the image.

Accordingly, in recent years, a transparent substance having a refractive index close to the refractive indexes of the translucent sheet and the liquid crystal module material, as compared to air, is filled in the gap between the display surface of the image display device and the translucent sheet, whereby visibility of the image displayed on the image display device is enhanced. One such transparent substance is an optically clear adhesive (OCA).

Currently, lamination of two substrates with a sheet-type OCA is typically conducted under vacuum conditions in order to avoid air entrapment in the laminate. This is particularly typical when both substrates are rigid (“rigid-to-rigid lamination”). The use of OCAs is becoming increasingly popular as the size of the substrates to which the OCA is being applied are becoming larger, i.e., greater than 10-inches diagonal. As the size of lamination increases, the vacuum process becomes increasingly resource-intensive, requiring costly equipment and longer TACT (total assembly cycle time).

Also due to customer interest, the displays are also becoming thinner and lighter in weight, making them often more fragile to the sometimes harsh lamination conditions. This can lead to mechanical damage or optical distortions (Mura) in the assembled modules.

### SUMMARY

In one embodiment, the present invention is a micro-structured optically clear adhesive including a first major surface and a second major surface. At least one of the first and second major surfaces comprises a micro-structured surface of interconnected micro-structures in at least one of the planar dimensions (x-y). The micro-structured optically clear adhesive has a tan delta value of at least about 0.3 at a lamination temperature and is non-crosslinked or lightly crosslinked. The micro-structured surface may include indentations having a depth of between about 5 and about 80 microns.

In another embodiment, the present invention is a method of laminating a first substrate and a second substrate without the use of a vacuum. The method includes providing a micro-structured optically clear adhesive, comprising a first major surface and a second major surface, wherein at least one major surface comprises a micro-structured surface, removing a release liner, which can be micro-structured or not, from a first major surface of the micro-structured optically clear adhesive, wherein the first major surface can be micro-structured or not, contacting the first major surface of the micro-structured optically clear adhesive with a surface of the first substrate, removing a micro-structured release liner from a second major surface of the micro-structured optically clear adhesive to expose a micro-structured surface, and contacting the micro-structured surface with a surface of the second substrate. The micro-structured surface includes interconnected micro-structures in at least one planar dimension. The micro-structured optically clear adhesive has a tan delta value of at least about 0.3 at a lamination temperature.

In yet another embodiment, the present invention is a method of vacuumless lamination of a first substrate and a second substrate. The method includes providing a micro-structured optically clear adhesive comprising a first major surface and a second major surface, wherein at least one major surface comprises a micro-structured surface, contacting a surface of the micro-structured optically clear adhesive with a surface of the first substrate, applying a micro-structured surface of the optically clear adhesive with a surface of the second substrate to form a bond line, allowing point-to-point contact between the micro-structured surface and the surface of the second substrate, uniformly spreading the optically clear adhesive along the surface of the second substrate, and filling in continuous, open air space to substantially remove air from the bond line to form a laminate. The micro-structured surface includes interconnected micro-structures in at least one planar dimension. The micro-structured optically clear adhesive has a tan delta value of at least about 0.3 at a temperature of between about 20° C. and about 60° C.

### BRIEF DESCRIPTION OF THE DRAWINGS

FIG. 1 is a cross-sectional view of a micro-structured, super shallow liner used to form a first embodiment of a micro-structured pressure-sensitive adhesive of the present invention.

FIG. 2a is a cross-sectional view of a micro-structured double-feature liner used to form a second embodiment of a micro-structured pressure-sensitive adhesive of the present invention.

FIG. 2b is an enlarged, cross-sectional view of a protrusion of the micro-structured double feature liner of FIG. 2a.

FIG. 3 is a cross-sectional view of a micro-structured liner having a grid pattern used to form a third embodiment of a micro-structured pressure-sensitive adhesive of the present invention.

FIG. 4a is a cross-sectional view of a laminate formed using a micro-structured pressure-sensitive adhesive, immediately after contacting the micro-structured adhesive surface to the surface of a substrate.

FIG. 4b is a cross-sectional view of the laminate of FIG. 4a, after uniformly spreading the optically clear adhesive along the surface of the substrate and filling in the continuous, open air space, to remove the air from the bond line.

FIG. 5 is a diagram showing wetting behavior of micro-structured pressure-sensitive adhesives of the present invention and comparative micro-structured pressure-sensitive adhesives as a function of time and additional UV exposure.

FIG. 6 is a diagram showing wetting behavior of micro-structured pressure-sensitive adhesives of the present invention and comparative micro-structured pressure-sensitive adhesives as a function of time and additional UV exposure.

FIG. 7 is a diagram showing wetting behavior of micro-structured pressure-sensitive adhesives of the present invention.

### DETAILED DESCRIPTION

All numbers are herein assumed to be modified by the term “about.” The recitation of numerical ranges by endpoints includes all numbers subsumed within that range (e.g., 1 to 5 includes 1, 1.5, 2, 2.75, 3, 3.80, 4, and 5). All parts recited herein are by weight unless otherwise indicated.

The pressure-sensitive adhesive (PSA) and lamination method of the present invention are useful for the lamination of substrates, such as, display and/or touch panels, and particularly larger displays and/or touch panels. In some embodiments, the present invention is particularly suited for the lamination of a first substrate and a second substrate, wherein at least one of the first and second substrates comprises a topographical feature, which can create a space or air gap between the substrates being laminated. An example of this is the bonding of a display substrate having an ink step, i.e. a topographical feature, which creates an air gap when bonding to a cover glass or the like. In general, the lamination method is useful for air-bubble-free lamination of two surfaces, and particularly rigid surfaces, which can be transparent (for example glass to glass) or opaque (for example computer touch pad to back panel assembly). In one embodiment, the PSA is a flowable micro-structured (MS) optically clear adhesive (OCA). The MS OCA has a micro-structured surface, which is prepared by contacting an OCA with a micro-structured liner during a coating process or a lamination process. The lamination method of the present invention using the MS OCA allows for the production of defect-free assemblies using a vacuumless lamination process for lamination. The MS OCA is particularly useful for larger size laminations and rigid-to-rigid laminations because it can provide defect-free lamination without the use of vacuum bonding equipment and processing. While the method of the present invention is discussed as not requiring a vacuum during the lamination process, a vacuum may optionally be used without departing from the intended scope of the present invention.

The laminates produced using the lamination method of the present invention include the MS OCA layer positioned between a first substrate and a second substrate. For the purposes of the present invention, a laminate is defined as including at least a first substrate, a second substrate, and a MS OCA positioned between the first and second substrates. The substantially defect-free, stress-free and dimensionally distortion-free laminates and resulting optical assemblies are accomplished by applying heat and/or pressure before the MS OCA is crosslinked, if desired.

Any suitable, transparent optical substrates can be bonded using the vacuumless lamination method of the present invention. The optical substrates may be formed of glass, polymers, composites and the like. The type of material used for the optical substrates generally depends on the application in which the assembly will be used. In one embodiment, the optical substrates include a display panel and a substantially light transmissive substrate.

Suitable optical substrates can be of any Young's modulus and may be, for example, rigid (e.g., the optical substrate may be a 6 millimeter-thick sheet of plate glass) or flexible (e.g., the optical substrate may be a 37 micrometer-thick polyester film). The method can thus be used for rigid-to-rigid lamination, rigid-to-flexible lamination, or flexible-to-flexible lamination.

As with the type of material, the dimensions and surface topography of the optical substrates generally depend on the application in which the optical assembly will be used. The surface topography of an optical substrate may also be roughened. Optical substrates having rough surface topographies can also be effectively laminated in accordance with the present invention.

### Micro-Structured Optically Clear Adhesive

As mentioned above, an optical assembly having a large size or area can be difficult to manufacture, especially if efficiency and stringent optical quality are desired. Additionally, some optical assemblies have topographical features between optical components, e.g. an ink step or just unevenness or waviness between substrates due to lack of planarity between the two substrates being bonded. This topography can cause increased defects, if the adhesive (typically a transfer adhesive) used to bond the assemblies does not adequately fill the space or air gap created by the topography. One approach to improving the defect issues associated with optical assemblies having topographical features is to use liquid, curable adhesive compositions that can be subsequently cured after application. Use of a liquid, curable adhesive composition enables the space or air gap between optical components, created by the topographical feature, to be filled by pouring or injecting the liquid, curable composition into the space or gap followed by curing the composition to bond the components together. However, these commonly used compositions have long flow-out times which contribute to inefficient manufacturing methods for large optical assemblies. These liquid, curable compositions also have a tendency to shrink during curing, causing significant stress on the assembly.

In the present invention, useful adhesives include those that are flowable and, optionally, curable, having the ability to fill a space or air gap between substrates being laminated. The flowable, and optionally curable gap filling composition may be a hot-melt OCA, solvent coated OCA, on-web polymerized OCA or heat-activated adhesive. While heat-activated adhesives are not pressure-sensitive adhesives, they may be used in the present invention if they flow (i.e., have a tan delta of at least about 0.3) when heated, such as in an autoclave.

The MS OCA may be manufactured in transfer tape format that is useful to bond optical assemblies, e.g. display substrates, including those having one or more topographical features that create a space or air gap between the substrates. In this transfer tape manufacturing process, a liquid, curable composition can be applied between two release liners, at least one of which is transparent to UV radiation that is useful for curing. The liquid, curable composition can then be cured (polymerized) by exposure to actinic radiation at a wavelength at least partially absorbed by a photoinitiator contained therein. Alternatively, a thermally activated free-radical initiator may be used, where the liquid, curable composition can be coated between two release liners and exposed to heat to complete the polymerization of the composition. At least one of the release liners is micro-structured. If neither liner is micro-structured, at least one of the liners is exchanged for a micro-structured liner after the polymerization is completed.

In yet a different method, the flowable, and optionally curable composition can be solvent coated and dried on a liner, which can be micro-structured or not. Once the flowable, and optionally curable composition is dried, a second release liner can be applied to cover the OCA. At least one of the first or second release liners is micro-structured.

A transfer tape that includes a pressure-sensitive adhesive can be thus formed. The formation of a transfer tape can reduce stress in the MS OCA by allowing the flowable, and optionally curable composition to relax prior to lamination. For example, in a typical assembly process, one of the release liners of the transfer tape can be removed and the flowable, and optionally curable composition can be applied to the display assembly. Then, the second release liner can be removed and lamination to the substrate can be completed. Finally, the assembled display components can be submitted to an autoclave step to finalize the bond and make the optical assembly free of lamination defects.

The MS OCA has desirable flow characteristics that lead to substantially bubble-free lamination and short TACT (Total Assembly Cycle Time). The MS OCA allows for trapped bubbles formed during lamination to easily escape the adhesive/substrate interface, resulting in a bubble-free laminate after time or application of heat and/or pressure, such as in an autoclave. As a result, minimum lamination defects are observed after lamination and optional autoclave treatment. The combined benefits of good substrate wetting and easy bubble removal enables an efficient lamination process with greatly shortened cycle times. Additionally, the good stress relaxation and substrate adhesion from the adhesive allow for durable bonding of the laminate (e.g., no bubble/delamination after accelerated aging tests). Because a vacuum is not required during lamination, the cost of lamination and lamination equipment is also substantially reduced. To achieve these effects, the MS OCA has certain rheological properties, such as a high tan delta values at process conditions (i.e. lamination, and if used autoclave step). In some cases a low storage modulus (G′) may also be beneficial during the initial lamination step.

The MS OCA transfer tape may have sufficient compliance (for example, low shear storage modulus, G′, at the lamination temperature, typically 25° C., of <1×10⁶ Pascal (Pa) when measured at 1 Hz frequency), to enable good wetting by being able to deform quickly and to comply to contours. The flow of the adhesive composition can be reflected in the high tan delta value (measured by DMA) of the material over a broad range of temperatures (i.e. tan δ>0.5 between the glass transition temperature (Tg) of the adhesive and about 50° C. or slightly higher). In one embodiment, when a hot-melt or flowable OCA is used, the MS OCA has a tan delta of at least about 0.3, particularly at least about 0.5, and more particularly at least about 0.7 at the lamination temperature. For heat-activated adhesives, the MS OCA has a tan delta of at least about 0.3, particularly at least about 0.5, and more particularly at least about 0.7 at the heat-activation temperature.

The MS OCA exhibits elevated increased tan delta values in the region of room temperature (about 20° C.) and about 60° C. and often increases with increasing temperatures, resulting in facile lamination by common techniques such as roller lamination. Tan delta values indicate the viscous to elastic balance of the MS OCA. A high tan delta corresponds to a more viscous character and thus, reflects the ability to flow. Generally, a higher tan delta value equates to higher flow properties. The ability of an adhesive composition to flow during the application/lamination process is a significant factor in the performance of the adhesive in terms of wetting and ease of lamination.

The MS OCA is either non-crosslinked or lightly crosslinked. The extent to which an adhesive composition is crosslinked can be determined from the percent of gel content in the adhesive composition. The percent gel content is determined by an extraction technique using a solvent suitable to extract monomer, oligomer and polymer that is not connected to the lightly crosslinked, adhesive network. The gel content is defined as follows: Gel Content (%)=(Mass of insoluble constituent/Mass of the initial adhesive)×100. For a given amount of crosslinking reagent, this percentage may change depending on the molecular weight and molecular weight distribution of the polymer chains that are being crosslinked. If the MS OCA has too much crosslinking, it will be too elastic and may cause incomplete healing of the structure or delayed bubbles in the area of the former micro-structure pattern. In one embodiment, the MS OCA has a gel content of about 50% or less, particularly about 30% or less. In another embodiment the MS OCA has substantially no gel content, i.e., less than about 2% gel content, prior to lamination. In yet another embodiment, the MS OCA is completely soluble in the extraction solvent, i.e. no gel is present.

An adhesive of the present invention is considered to be optically clear if it exhibits an optical transmission of at least about 80% and a haze value below about 10%, as measured on a 25 μm thick sample. In some embodiments, the optical transmission may be at least about 85%, 90%, 95% or even higher, while the haze value may be below about 8%, 5%, 2% or even lower. The % transmission and haze values are typically determined after the micro-structure has completely healed. The MS OCA layer has optical properties suitable for the intended application. For example, the MS OCA layer may have at least about 85% transmission over the range of from about 400 to about 720 nm. The MS OCA layer may have, per millimeter thickness, a transmission of greater than about 85% at 460 nm, greater than about 90% at 530 nm and greater than about 90% at 670 nm. In one embodiment, the MS OCA layer has a transmission percentage of at least about 80%, particularly about 85% and more particularly about 88% after 30 days at room temperature and controlled humidity conditions (CTH). In another embodiment, the MS OCA layer has a transmission percentage of at least about 75%, particularly about 77.5% and more particularly about 80% after 30 days of heat aging at 65° C. and 90% relative humidity. In yet another embodiment, the MS OCA layer has a transmission percentage of at least about 75%, particularly about 77.5% and more particularly about 80% after 30 days of heat aging at 70° C. These transmission characteristics provide for uniform transmission of light across the visible region of the electromagnetic spectrum which is important to maintain the color point if the optical assembly is used in full color displays. The MS OCA layer particularly has a refractive index that matches or closely matches that of the first and/or second optical substrates. In one embodiment, the MS OCA layer has a refractive index of from about 1.4 to about 1.6.

Examples of suitable optically clear adhesives include hot-melt OCAs, solvent cast OCAs, and OCAs polymerized on the web. These MS OCAs work effectively for rigid-to-rigid lamination under vacuumless conditions. Hot-melt MS OCAs have hot-melt properties both during and after lamination and may have post-crosslinkable properties under irradiation, such as from a UV source. At room temperature the hot-melt MS OCA has the shape and dimensional stability of a fully cured optically clear adhesive film and can be die cut and laminated as a dry film. With very moderate heat and/or pressure, the hot-melt MS OCA will flow to completely wet out a substrate without creating excessive force on the substrate that may cause it to dimensionally deform, and any remaining stresses in the adhesive can be relaxed prior to the part being finished. If so desired, once the hot-melt MS OCA has the chance to wet the substrate, an additional covalent crosslinking step can be used to “set” the adhesive. Examples of such a crosslinking step include, but are not limited to: radiation induced crosslinking (UV, e-beam, gamma irradiation, etc.), thermal curing and moisture curing. Alternatively, the adhesive may be self-crosslinking upon cooling using thermo-reversible crosslinking mechanisms, such as, ionomeric crosslinking or physical crosslinking due to phase separation of higher glass transition (T_{g}) segments, such as those found in graft copolymers or block copolymers.

A number of different hot-melt MS OCAs can be used in this invention. In some embodiments, they have pressure-sensitive adhesive properties. True heat activated adhesives (i.e., ones that have very low or no room temperature tack) may also be used provided they are optically clear and have a sufficiently high melting point or glass transition temperature so as to be durable for display applications. Because most display assemblies are heat sensitive, the typical heat activation temperature (i.e., the temperature at which sufficient flow, compliance, and tack is achieved to successfully bond the display together) is below 120° C., particularly below 100° C. and more particularly below 80° C. Typically, the display fabrication process is carried out above 40° C. and at times above 60° C.

The shear storage modulus (G′), measured at a frequency of 1 Hz, of the hot-melt MS OCA before ultraviolet (UV) crosslinking is typically between 1.0×10⁴ Pa or more at 30° C. and 5.0×10⁴ Pa or less at 80° C. When the shear storage modulus at 30° C. and 1 Hz is about 1.0×10⁴ Pa or more, the hot-melt MS OCA can maintain cohesive strength necessary for processing, handling, shape keeping and the like. In addition, when the shear storage modulus at 30° C. and 1 Hz is about 3×10⁵ Pa or less, initial adherence (tack) necessary for applying a hot-melt MS OCA can be imparted to the pressure-sensitive adhesive. When the shear storage modulus at 80° C. and 1 Hz is about 5.0×10⁴ Pa or less, the hot-melt MS OCA can conform to a feature in a predetermined amount of time (for example, from several seconds to several minutes) and flow to allow minimal to no formation of a gap in the vicinity thereof. In addition, excessive lamination force or autoclave pressure can be avoided, both of which can cause dimensional distortion of a sensitive substrate.

The shear storage modulus of the hot-melt MS OCA after UV crosslinking is about 1.0×10³ Pa or more at 130° C. and 1 Hz. When the storage modulus at 130° C. and 1 Hz is about 1.0×10³ Pa or more, the hot-melt MS OCA, after ultraviolet crosslinking, can be kept from flowing and adhesion with long-term reliability can be realized.

The hot-melt MS OCA of the present invention has the above-described viscoelastic characteristics at a stage before covalent crosslinking so that the hot-melt MS OCA can be made to conform to features on the surface of an adherend, such as a surface protective layer, by applying heat and/or pressure after laminating together the hot-melt MS OCA and the adherend at an ordinary working temperature. Thereafter, when covalent crosslinking is performed, the cohesive strength of the hot-melt MS OCA is raised and as a result, due to the change in viscoelastic characteristics of the hot-melt MS OCA, highly reliable adhesion and durability of the display assembly can be realized.

Examples of suitable hot-melt MS OCAs include, but are not limited to: poly(meth)acrylates and derived adhesives, thermoplastic polymers like silicone (e.g., silicone polyureas), polyisobutylenes, polyesters, polyurethanes and combinations thereof. The term (meth)acrylate includes acrylate and methacrylate. Particularly suitable are (meth)acrylates because they tend to be easy to formulate and moderate in cost, and their rheology can be tuned to meet the requirements of this disclosure. In one embodiment, the hot-melt MS OCA is a (meth)acrylic copolymer of a monomer containing a (meth)acrylic acid ester having an ultraviolet-crosslinkable site. The term (meth)acrylic includes acrylic and methacrylic.

(Meth)acrylate adhesives can be selected from random copolymers, graft copolymers, and block copolymers. Ionomerically crosslinked adhesives, those using metal ions or those using polymers, may also be used. Examples of polymeric ionic crosslinking can be found in U.S. Pat. Nos. 6,720,387 and 6,800,680 (Stark et al.). Examples of suitable block copolymers include those disclosed in U.S. Pat. No. 7,255,920 (Everaerts et al.), U.S. Pat. No. 7,494,708 (Everaerts et al.) and U.S. Pat. No. 8,039,104 (Everaerts et al.).

The (meth)acrylic copolymer contained in the hot-melt MS OCA can perform the ultraviolet crosslinking by itself. Thus, a crosslinkable component having a low molecular weight, such as a multifunctional monomer or oligomer, need not be generally added to the hot-melt MS OCA. In addition, a polymer compounded with a multi-functional monomer or oligomer and a free-radical initiator can also be used in the present invention.

As for the (meth)acrylic acid ester having an ultraviolet-crosslinkable site, a (meth)acrylic acid ester having, as defined above, a site capable of being activated by ultraviolet irradiation and forming a covalent link with another portion in same or different (meth)acrylic copolymer chain can be used. There are various structures acting as an ultraviolet-crosslinkable site. For example, a structure capable of being excited by ultraviolet irradiation and extracting a hydrogen radical from another portion in the (meth)acrylic copolymer molecule or from another (meth)acrylic copolymer molecule can be employed as the ultraviolet-crosslinkable site. Examples of such a structure include, but are not limited to: a benzophenone structure, a benzil structure, an o-benzoylbenzoic acid ester structure, a thioxanthone structure, a 3-ketocoumarin structure, an anthraquinone structure and a camphorquinone structure. Each of these structures can be excited by ultraviolet irradiation and, in the excited state, can extract a hydrogen radical from the (meth)acrylic copolymer molecule. In this way, a radical is produced on the (meth)acrylic copolymer to cause various reactions in the system, such as formation of a crosslinked structure due to bonding of produced radicals with each other, production of a peroxide radical by a reaction with an oxygen molecule, formation of a crosslinked structure through the produced peroxide radical, and extraction of another hydrogen radical by the produced radical, causing the (meth)acrylic copolymer to finally be crosslinked.

Among the structures listed above, a benzophenone structure is advantageous due to various properties, such as transparency and reactivity. Examples of (meth)acrylic acid esters having such a benzophenone structure include, but are not limited to: 4-acryloyloxybenzophenone, 4-acryloyloxyethoxybenzophenone, 4-acryloyloxy-4′-methoxybenzophenone, 4-acryloyloxyethoxy-4′-methoxybenzophenone, 4-acryloyloxy-4′-bromobenzophenone, 4-acryloyloxyethoxy-4′-bromobenzophenone, 4-methacryloyloxybenzophenone, 4-methacryloyloxyethoxybenzophenone, 4-methacryloyloxy-4′-methoxybenzophenone, 4-methacryloyloxyethoxy-4′-methoxybenzophenone, 4-methacryloyloxy-4′-bromobenzophenone, 4-methacryloyloxyethoxy-4′-bromobenzophenone, and mixtures thereof.

The amount of (meth)acrylic acid ester having an ultraviolet-crosslinkable site is based on the total mass of monomers. In one embodiment, 0.1 mass % or more, 0.2 mass % or more or 0.3 mass % or more, and 2 mass % or less, 1 mass % or less, or 0.5 mass % or less is used. By setting the amount of the (meth)acrylic acid ester having an ultraviolet-crosslinkable site to 0.1 mass % or more based on the total mass of monomers, the adhesive strength of the hot-melt MS OCA after ultraviolet crosslinking can be enhanced and highly reliable adhesion and durability can be achieved. By setting the amount to 2 mass % or less, the modulus of the hot-melt MS OCA after ultraviolet crosslinking can be kept in an appropriate range (i.e., shear loss and storage modulus can be balanced to avoid excessive elasticity in the crosslinked adhesive).

Generally, for the purpose of imparting suitable viscoelasticity to the hot-melt MS OCA and ensuring good wettability to an adherend, the monomer constituting the (meth)acrylic copolymer contains a (meth)acrylic acid alkyl ester with an alkyl group having a carbon number of 2 to 26. Examples of such a (meth)acrylic acid alkyl ester include, but are not limited to, a (meth)acrylate of a non-tertiary alkyl alcohol with the alkyl group having a carbon number of 2 to 26, and mixtures thereof. Specific examples include, but are not limited to: ethyl acrylate, ethyl methacrylate, n-butyl acrylate, n-butyl methacrylate, isobutyl acrylate, isobutyl methacrylate, hexyl acrylate, hexyl methacrylate, 2-ethylhexyl acrylate, 2-ethylhexyl methacrylate, isoamyl acrylate, isooctyl acrylate, isononyl acrylate, decyl acrylate, isodecyl acrylate, isodecyl methacrylate, lauryl acrylate, lauryl methacrylate, tridecyl acrylate, tridecyl methacrylate, tetradecyl acrylate, tetradecyl methacrylate, hexadecyl acrylate, hexadecyl methacrylate, stearyl acrylate, stearyl methacrylate, isostearyl acrylate, isostearyl methacrylate, eicosanyl acrylate, eicosanyl methacrylate, hexacosanyl acrylate, hexacosanyl methacrylate, 2-methylbutyl acrylate, 4-methyl-2-pentyl acrylate, 4-tert-butylcyclohexyl methacrylate, cyclohexyl methacrylate, isobornyl acrylate, and mixtures thereof. Above all, ethyl acrylate, n-butyl acrylate, 2-ethylhexyl acrylate, isooctyl acrylate, lauryl acrylate, isostearyl acrylate, isobornyl acrylate, or mixtures thereof are suitably used.

The amount of (meth)acrylic acid alkyl ester with an alkyl group having a carbon number of 2 to 26 is based on the total mass of monomers. In one embodiment, 60 mass % or more, 70 mass % or more or 80 mass % or more, and 95 mass % or less, 92 mass % or less or 90 mass % or less is used. By setting the amount of the (meth)acrylic acid alkyl ester with an alkyl group having a carbon number of 2 to 26 to 95 mass % or less based on the total mass of monomers, the adhesive strength of the hot-melt MS OCA can be sufficiently ensured, whereas by setting the amount to 60 mass % or more, the modulus of the pressure-sensitive adhesive sheet can be kept in an appropriate range and the hot-melt MS OCA can have good wettability to an adherend.

A hydrophilic monomer may be contained in the monomer constituting the (meth)acrylic copolymer. By using a hydrophilic monomer, the adhesive strength of the hot-melt MS OCA can be enhanced and/or hydrophilicity can be imparted to the hot-melt MS OCA. In the case where the hot-melt MS OCA imparted with hydrophilicity is used, for example, in an image display device, because the pressure-sensitive adhesive sheet can absorb water vapor inside of the image display device, whitening due to dew condensation of such water vapor can be suppressed. This is advantageous particularly when the surface protective layer is a low moisture permeable material such as a glass plate or inorganic deposited film and/or when the image display device or the like using the pressure-sensitive adhesive sheet is used in a high-temperature high-humidity environment.

Examples of suitable hydrophilic monomers include, but are not limited to: an ethylenically unsaturated monomer having an acidic group such as carboxylic acid and sulfonic acid, a vinylamide, an N-vinyl lactam, a (meth)acrylamide and mixtures thereof. Specific examples thereof include, but are not limited to: acrylic acid, methacrylic acid, itaconic acid, maleic acid, styrenesulfonic acid, N-vinylpyrrolidone, N-vinylcaprolactam, N,N-dimethyl(meth)acrylamide, N,N-diethyl(meth)acrylamide, N-octyl acrylamide, N-isopropylacrylamide, N-morpholino acrylate, acrylamide, (meth)acrylonitrile and mixtures thereof.

From the standpoint of adjusting the modulus of the (meth)acrylic copolymer and ensuring wettability to an adherend, a (meth)acrylic acid hydroxyalkyl ester with the alkyl group having a carbon number of 4 or less, a (meth)acrylate containing an oxyethylene group, an oxypropylene group, an oxybutylene group or a group formed by connecting a combination of a plurality of these groups, a (meth)acrylate having a carbonyl group in the alcohol residue, and mixtures thereof may also be used as the hydrophilic monomer. Specific examples thereof include, but are not limited to: 2-hydroxyethyl acrylate, 2-hydroxyethyl methacrylate, 2-hydroxypropyl acrylate, 2-hydroxypropyl methacrylate, 2-hydroxybutyl acrylate, 2-hydroxybutyl methacrylate, 4-hydroxybutyl acrylate, and a (meth)acrylate represented by the formula:

CH₂═C(R)COO-(AO)ₚ—(BO)_{q}R′ (1)

(wherein each A is independently a group selected from the group consisting of (CH₂)ᵣCO, CH₂CH₂, CH₂CH(CH₃) and CH₂CH₂CH₂CH₂, each B is independently a group selected from the group consisting of (CH₂)ᵣCO, CO(CH₂)ᵣ, CH₂CH₂, CH₂CH(CH₃) and CH₂CH₂CH₂CH₂, R is hydrogen or CH₃, R′ is hydrogen or a substituted or unsubstituted alkyl group or aryl group, and each of p, q and r is an integer of 1 or more).

In formula (I), A is particularly CH₂CH₂ or CH₂CH(CH₃) in view of easy availability in industry and control of moisture permeability of the obtained pressure-sensitive adhesive sheet. B is particularly CH₂CH₂ or CH₂CH(CH₃) in view of, similarly to A, easy availability in industry and control of moisture permeability of the obtained pressure-sensitive adhesive sheet. In the case where R′ is an alkyl group, the alkyl group may be any of linear, branched or cyclic. In one embodiment, an alkyl group having a carbon number of from 1 to 12 or from 1 to 8 (specifically, methyl group, ethyl group, butyl group or octyl group) and exhibiting excellent compatibility with the (meth)acrylic acid alkyl ester with the alkyl group having a carbon number of 2 to 12 is used as R′. The numbers of p, q and r are not particularly limited in their upper limits, but when p is 10 or less, q is 10 or less and r is 5 or less, compatibility with the (meth)acrylic acid alkyl ester with the alkyl group having a carbon number of 2 to 12 can be more enhanced.

A hydrophilic monomer having a basic group such as an amino group may also be used. Blending of a (meth)acrylic copolymer obtained from a monomer containing a hydrophilic monomer having a basic group with a (meth)acrylic copolymer obtained from a monomer containing a hydrophilic monomer having an acid group may increase the viscosity of the coating solution and thereby increase the coating thickness, controlling the adhesive strength, etc. Furthermore, even when an ultraviolet-crosslinkable site is not contained in the (meth)acrylic copolymer obtained from a monomer containing a hydrophilic monomer having a basic group, the effects of the blending above can be obtained and such a (meth)acrylic copolymer can be crosslinked through an ultraviolet-crosslinkable site of another (meth)acrylic copolymer. Specific examples thereof include, but are not limited to: N,N-dimethylaminoethyl acrylate, N,N-dimethylaminoethyl methacrylate (DMAEMA), N,N-diethylaminoethyl methacrylate, N,N-dimethylaminoethylacrylamide, N,N-dimethylaminoethylmethacrylamide, N,N-dimethylaminopropylacrylamide, N,N-dimethylaminopropylmethacrylamide, vinylpyridine and vinylimidazole.

As for the hydrophilic monomer, one kind may be used, or a plurality of kinds may be used in combination. The term “hydrophilic monomer” is a monomer having a high affinity for water, specifically, a monomer that dissolves in an amount of 5 g or more per 100 g of water at 20° C. In the case of using a hydrophilic monomer, the amount of the hydrophilic monomer is, based on the total mass of monomers, generally from about 5 to about 40 mass % and particularly from about 10 to about 30 mass %. In the latter case, the above-described whitening can be more effectively suppressed and at the same time, high flexibility and high adhesive strength can be obtained.

Other monomers may be contained as the monomer used in the (meth)acrylic copolymer within the range not impairing the characteristics of the pressure-sensitive adhesive sheet. Examples include, but are not limited to: a (meth)acrylic monomer other than those described above, and a vinyl monomer such as vinyl acetate, vinyl propionate and styrene.

The (meth)acrylic copolymer can be formed by polymerizing the above-described monomer in the presence of a polymerization initiator. The polymerization method is not particularly limited and the monomer may be polymerized by a normal radical polymerization such as solution polymerization, emulsion polymerization, suspension polymerization and bulk polymerization. Generally, radical polymerization using a thermal polymerization initiator is employed so as to allow for no reaction of the ultraviolet-crosslinkable site. Examples of the thermal polymerization initiator include, but are not limited to: an organic peroxide such as benzoyl peroxide, tert-butyl perbenzoate, cumyl hydroperoxide, diisopropyl peroxydicarbonate, di-n-propyl peroxydicarbonate, di(2-ethoxyethyl)peroxydicarbonate, tert-butyl peroxyneodecanoate, tert-butyl peroxypivalate, (3,5,5-trimethylhexanoyl)peroxide, dipropionyl peroxide and diacetyl peroxide; and an azo-based compound such as 2,2′-azobisisobutyronitrile, 2,2′-azobis(2-methylbutyronitrile), 1,1′-azobis(cyclohexane-1-carbonitrile), 2,2′-azobis(2,4-dimethylvaleronitrile), 2,2′-azobis(2,4-dimethyl-4-methoxyvaleronitrile), dimethyl 2,2′-azobis(2-methylpropionate), 4,4′-azobis(4-cyanovaleric acid), 2,2′-azobis(2-hydroxymethylpropionitrile) and 2,2′-azobis[2-(2-imidazolin-2-yl)propane]. The average molecular weight of the obtained (meth)acrylic copolymer is generally 30,000 or more, 50,000 or more, or 100,000 or more, and 1,000,000 or less, 500,000 or less, or 300,000 or less. If the glass transition temperature is higher, the adhesive is no longer tacky at room temperature but it may still be used as a heat-activatable adhesive provided it can be activated to bond to the substrates within the temperature ranges specified above.

As another ultraviolet cross-linkable site, a (meth)acryloyl structure can be also employed. A (meth)acrylic copolymer having a (meth)acryloyl structure in the side chain is cross-linked by ultraviolet irradiation. In this system, by adding a photoinitiator which is capable of being excited by visible light as well as ultraviolet light, the (meth)acrylic copolymer is able to be cross-linked not only by ultraviolet irradiation but also by visible light irradiation.

A (meth)acrylic copolymer having an (meth)acryloyl structure in the side chain is obtained by reacting a (meth)acrylic copolymer which has a reactive group in the side chain with a reactive (meth)acrylate. A (meth)acrylic copolymer having an (meth)acryloyl structure in the side chain is obtained by two step reaction. At the first step, a (meth)acrylic copolymer which has a reactive group in the side chain is synthesized. At the next step, the prepared polymer is reacted with a reactive (meth)acrylate.

Various combinations of (meth)acrylic copolymers which have a reactive group in the side chain and a reactive (meth)acrylate are possible. An exemplary combination is a (meth)acrylic copolymer which has a hydroxyl group in the side chain and a (meth)acrylate which has an isocyanate group. A (meth)acrylic copolymer which has a hydroxyl group in the side chain is prepared by copolymerization with, for example: 2-hydroxyethyl acrylate, 2-hydroxyethyl methacrylate, 2-hydroxypropyl acrylate, 2-hydroxypropyl methacrylate, 2-hydroxybutyl acrylate, 2-hydroxybutyl methacrylate, 4-hydroxybutyl acrylate. Specific examples of a (meth)acrylate which has isocyanate group include, but are not limited to, 2-acryloyloxyethyl isocyanate, 2-methacryloyloxyethyl isocyanate, or 1,1-bis(acryloyloxymethyl)ethyl isocyanate.

The hot-melt MS OCA may contain additional components such as filler and antioxidant, other than the above-described (meth)acrylic copolymer. However, the (meth)acrylic copolymer itself has properties necessary for use as a hot-melt MS OCA, and therefore the additional components are optional.

The storage modulus of the pressure-sensitive adhesive sheet can be adjusted by appropriately varying the kind, molecular weight and blending ratio of monomers constituting the (meth)acrylic copolymer contained in the pressure-sensitive adhesive sheet and the polymerization degree of the (meth)acrylic copolymer. For example, the storage modulus rises when an ethylenically unsaturated monomer having an acidic group is used, and the storage modulus lowers when the amount of the (meth)acrylic acid alkyl ester with the alkyl group having a carbon number of 2 to 26, the (meth)acrylic acid hydroxyalkyl ester with the alkyl group having a carbon number of 4 or less, the (meth)acrylate containing an oxyethylene group, an oxypropylene group, an oxybutylene group or a group formed by connecting a combination of a plurality of these groups, or the (meth)acrylate having a carbonyl group in the alcohol residue is increased. When the polymerization degree of the (meth)acrylic copolymer is increased, the storage modulus tends to rise at elevated temperatures (i.e. the rubbery plateau modulus becomes extended towards higher temperatures).

Blends of these polymers may also be used, such as for example block copolymers and random copolymers, or ionomerically crosslinked polymers and graft copolymers. Likewise, polymers may combine crosslinking methods such as ionomeric and physical crosslinking due to high Tg grafts or blocks in the polymer. Optionally, these polymers may be formulated with optically clear tackifiers and plasticizers that yield an optically clear adhesive composition. In the case of graft and block copolymers that are physically crosslinked, no additional crosslinking agents may be required. However, like for random copolymers that are not physically crosslinked, additional crosslinkers may be incorporated into the adhesive formulation. Examples of these may include, but are not limited to: hydrogen abstraction type crosslinkers (for example benzophenone and its derivatives) that are activated with UV light, silanes that can moisture cure, and combinations of multifunctional acrylates and photoinitiators.

Heat activation of the adhesive often requires moderate temperatures to avoid damage to the display components. Likewise, most of the heat activated adhesive applications expose at least part of the material to the viewing area of the display, making optical clarity a necessity. In addition, excessive stiffness of the adhesive or resistance to flow at the temperature of the assembly process may cause excessive stress to build up, leading to mechanical damage or dimensional distortion of the components or optical distortions in the display. Thus it is desirable that the rubbery plateau shear storage modulus (G′) of the adhesive at the process temperature is below 10⁵ Pascals and particularly less than 10⁴ Pascals. In addition, adhesives with low melt elasticity are preferred, favoring polymers with lower molecular weight. Typical polymers will have a weight average molecular weight of 700,000 or less and particularly 500,000 or less. Because of this, lower molecular weight acrylic hot melt adhesives, such as those described in U.S. Pat. No. 5,637,646 (Ellis); U.S. Pat. No. 6,806,320 (Everaerts et al.) and U.S. Pat. No. 7,255,920 (Everaerts et al.) are desired.

The hot-melt MS OCA can be formed from the (meth)acrylic copolymer alone or a mixture of the (meth)acrylic copolymer and optional components by using a conventional method such as solvent casting and extrusion processing. The pressure-sensitive adhesive sheet may have on one or both surfaces a release liner such as silicone-treated polyester film or polyethylene film. At least one of these liners is typically micro-structured for this MS OCA.

On-web polymerized MS OCAs can also be used in the present invention. The on-web polymerizable MS OCA composition generally includes an alkyl(meth)acrylate ester, wherein the alkyl group has 4 to 18 carbon atoms, a hydrophilic copolymerizable monomer, a free-radical generating initiator and optionally a molecular weight control agent. The adhesive composition may also optionally include a crosslinker and a coupling agent.

Examples of suitable alkyl(meth)acrylate esters include, but are not limited to: 2-ethylhexyl acrylate (2-EHA), isobornyl acrylate (IBA), iso-octylacrylate (IOA) and butyl acrylate (BA). The low Tg yielding acrylates, such as IOA, 2-EHA, and BA provide tack to the adhesive, while the high Tg yielding monomers like IBA allow for the adjustment of the Tg of the adhesive composition without introducing polar monomers. Examples of suitable hydrophilic copolymerizable monomers include, but are not limited to: acrylic acid (AA), 2-hydroxyethyl acrylate (HEA), and 2-hydroxy-propyl acrylate (HPA), ethoxyethoxyethyl acrylate, acrylamide (Acm) and N-morpholino acrylate (MoA). These monomers often also promote adhesion to the substrates encountered in display assembly. In one embodiment, the adhesive composition includes between about 60 to about 95 parts of the alkyl(methyl)acrylate ester, wherein the alkyl group has 4 to 26 carbon atoms, and between about 5 and about 40 parts and of the hydrophilic copolymerizable monomer. Particularly, the adhesive composition includes between about 65 to about 95 parts of the alkyl(methyl)acrylate ester, wherein the alkyl group has 4 to 26 carbon atoms, and between about 5 and about 35 parts of the hydrophilic copolymerizable monomer.

In one embodiment, the adhesive composition includes the reaction product of a miscible blend of an acrylic oligomer, a reactive diluent comprising a mixture of one or more monofunctional (meth)acrylate monomers, optionally a multifunctional acrylate or vinyl crosslinker, and a free-radical generating initiator. The acrylic oligomer can be a substantially water-insoluble acrylic oligomer derived from (methacrylate monomers). In general, (meth)acrylate refers to both acrylate and methacrylate functionality.

The acrylic oligomer can be used to control the viscous to elastic balance of the cured composition of the invention and the oligomer contributes mainly to the viscous component of the rheology. In order for the acrylic oligomer to contribute to the viscous rheology component of the cured composition, the (meth)acrylic monomers used in the acrylic oligomer can be chosen in such a way that glass transition of the oligomer is below 25° C., typically below 0° C. The oligomer can be made from (meth)acrylic monomers and can have a weight average molecular weight (Mw) of at least 1,000, typically 2,000. It should not exceed the entanglement molecular weight (Me) of the oligomer composition. If the molecular weight is too low, outgassing and migration of the component can be problematic. If the molecular weight of the oligomer exceeds Me, the resulting entanglements can contribute to a less desirable elastic contribution to the rheology of the adhesive composition. Mw can be determined by GPC. Me can be determined by measuring the viscosity of the pure material as a function of molecular weight. By plotting the zero shear viscosity versus molecular weight in a log/log plot the change in slope can be define as the entanglement molecular weight. Above the Me the slope will increase significantly due to the entanglement interaction. Alternatively, for a given monomer composition, Me can also be determined from the rubbery plateau modulus value of the polymer in dynamic mechanical analysis provided that the polymer density is known. The general Ferry equation G₀=rRT/Me provides a relationship between Me and the modulus G₀. Typical entanglement molecular weights for (meth)acrylic polymers are on the order of 30,000-60,000.

The (meth)acrylic monomers and their ratio used in the acrylic oligomer can be chosen in such a way that the acrylic oligomers, the monofunctional (meth)acrylate monomers, the optional multifunctional acrylate or vinyl crosslinkers, and the other components of the miscible blend used to form the adhesive layer remain compatible upon curing to yield the optically clear adhesive composition of this invention. An optically clear adhesive is defined as having a visible light transmission of at least about 80% and a haze value of below about 10%, as measured on a 25 μm thick sample. In general, this also means that the solubility parameters of the acrylic oligomer or oligomers and the other components in the miscible blend are relatively close or the same. Theoretical values of the solubility parameters can be calculated using different known equations and theories from the literature. These solubility parameters can be used to narrow down the choices of acrylic oligomer but experimental validation (i.e. curing and haze measurement) is needed to confirm the theoretical prediction.

In general, the acrylic oligomer can be generally free of multiple free-radically copolymerizable groups (such as pendant or terminal methacrylic, acrylic, fumaric, vinyl, allylic, or styrenic groups). Free-radically copolymerizable groups are generally absent to avoid excessive crosslinking of the cured composition. However, a limited amount of coreactivity is acceptable provided the elastic rheological component of the cured composition of the invention is not significantly increased due to this coreactivity. Thus, the acrylic oligomer may contain one free-radically reactive copolymerizable group (such as a pendant, or terminal methacrylic, acrylic, fumaric, vinyl, allylic, or styrenic group).

The acrylic oligomer can include a substantially water-insoluble acrylic oligomer derived from (meth)acrylate monomers. Substantially water-insoluble acrylic oligomer derived from (meth)acrylate monomers are well known and are typically used in urethane coatings technology. Due to their ease of use, favorable acrylic oligomers include liquid acrylic oligomer derived from (meth)acrylate monomers. The liquid acrylic oligomer derived from (meth)acrylate monomers can have a number average molecular weight (Mn) within the range of about 500 to about 10,000. Commercially available liquid acrylic oligomers also have a hydroxyl number of from about 20 mg KOH/g to about 500 mg KOH/g, and a glass transition temperature (Tg) of about −70° C. These liquid acrylic oligomers derived from (meth)acrylate monomers typically comprise recurring units of a hydroxyl functional monomer. The hydroxyl functional monomer is used in an amount sufficient to give the acrylic oligomer the desired hydroxyl number and solubility parameter. Typically the hydroxyl functional monomer is used in an amount within the range of about 2% to about 60% by weight (wt %) of the liquid acrylic oligomer. Instead of hydroxyl functional monomers, other polar monomers such as acrylic acid, methacrylic acid, itaconic acid, fumaric acid, acrylamide, methacrylamide, N-alkyl and N,N-dialkyl substituted acrylamide and methacrylamides, N-vinyl lactams, N-vinyl lactones, and the like can also be used to control the solubility parameter of the acrylic oligomer. Combinations of these polar monomers may also be used. The liquid acrylic oligomer derived from acrylate and (meth)acrylate monomers also typically comprises recurring units of one or more C1 to C20 alkyl (meth)acrylates whose homopolymers have a Tg below 25° C. It is important to select a (meth)acrylate that has low homopolymer Tg because otherwise the liquid acrylic oligomer can have a high Tg and may not stay liquid at room temperature. However, the acrylic oligomer does not always need to be a liquid, provided it can readily be solubilized in the balance of the adhesive blend used in this invention. Examples of suitable commercial (meth)acrylates include n-butyl acrylate, n-butyl methacrylate, lauryl acrylate, lauryl methacrylate, isooctyl acrylate, isononylacrylate, isodecylacrylate, tridecyl acrylate, tridecyl methacrylate, 2-ethylhexyl acrylate, 2-ethylhexyl methacrylate, and mixtures thereof. The proportion of recurring units of C1 to C20 alkyl acrylates or methacrylates in the acrylic oligomer derived from acrylate and methacrylate monomers depends on many factors, but most important among these are the desired solubility parameter and Tg of the resulting adhesive composition. Typically liquid acrylic oligomer derived from acrylate and methacrylate monomers can be derived from about 40% to about 98% alkyl (meth)acrylate monomers.

Optionally, the acrylic oligomer derived from (meth)acrylate monomers can incorporate additional monomers. The additional monomers can be selected from vinyl aromatics, vinyl halides, vinyl ethers, vinyl esters, unsaturated nitriles, conjugated dienes, and mixtures thereof. Incorporation of additional monomers may reduce raw material cost or modify the acrylic oligomer properties. For example, incorporating styrene or vinylacetate into the acrylic oligomer can reduce the cost of the acrylic oligomer.

The liquid acrylic oligomer is typically prepared by a suitable free-radical polymerization process. U.S. Pat. No. 5,475,073 (Guo) describes a process for making hydroxy-functional acrylic resins by using allylic alcohols or alkoxylated allylic alcohols. Generally, the allylic monomer is added into the reactor before the polymerization starts. Usually the (meth)acrylate is gradually fed during the polymerization. Typically, at least about 50% by weight, or at least about 70% by weight, of the (meth)acrylate is gradually added to the reaction mixture. The (meth)acrylate is added at such a rate as to maintain its steady, low concentration in the reaction mixture. The ratio of allylic monomer to (meth)acrylate is kept essentially constant. This helps to produce an acrylic oligomer having a relatively uniform composition. Gradual addition of the (meth)acrylate can enable the preparation of an acrylic oligomer having sufficiently low molecular weight and sufficiently high allylic alcohol or alkoxylated allylic alcohol content. Generally, the free-radical initiator is added to the reactor gradually during the course of the polymerization. Typically the addition rate of the free-radical initiator is matched to the addition rate of the acrylate or methacrylate monomer. With hydroxyalkyl methacrylate-containing oligomers, a solution polymerization is typically used. The polymerization, as taught in U.S. Pat. No. 4,276,212 (Khanna et al.), U.S. Pat. No. 4,510,284 (Gempel et al.), and U.S. Pat. No. 4,501,868 (Bouboulis et al.), is generally conducted at the reflux temperature of the solvent. The solvents can have a boiling point within the range of about 90° C. to about 180° C. Examples of suitable solvents are xylene, n-butyl acetate, methyl amyl ketone (MAK), and propylene glycol methyl ether acetate (PMAc). Solvent is charged into the reactor and heated to reflux temperature, and thereafter monomer and initiator are gradually added to the reactor.

Suitable liquid acrylic oligomers include copolymers of n-butyl acrylate and allyl monopropoxylate, n-butyl acrylate and allyl alcohol, n-butyl acrylate and 2-hydroxyethyl acrylate, n-butyl acrylate and 2-hydroxy-propyl acrylate, 2-ethylhexyl acrylate and allyl propoxylate, 2-ethylhexyl acrylate and 2-hydroxy-propyl acrylate, and the like, and mixtures thereof. Exemplary acrylic oligomers useful in the provided optical assembly are disclosed, for example, in U.S. Pat. No. 6,294,607 (Guo et al.) and U.S. Pat. No. 7,465,493 (Lu), as well as acrylic oligomer derived from acrylate and methacrylate monomers having the tradename JONCRYL (available from BASF, Mount Olive, N.J.) and ARUFON (available from Toagosei Co., Lt., Tokyo, Japan).

It is also possible to make the provided acrylic oligomers in-situ. For example, if on-web polymerization is used, a monomer composition may be prepolymerized by UV or thermally induced reaction. The reaction can be carried out in the presence of a molecular weight control agent, like a chain-transfer agent, such as a mercaptan, or a retarding agent such as, for example, styrene, α-methyl styrene, α-methyl styrene dimer, to control chain-length and molecular weight of the polymerizing material. When the control agent is consumed, the reaction can proceed to higher molecular weight and thus true high molecular weight polymer forming. Likewise, the polymerization conditions for the first step of the reaction can be chosen in such a way that only oligomerization happens, followed by a change in polymerization conditions that yields high molecular weight polymer. For example, UV polymerization under high intensity light can result in lower chain-length growth where polymerization under lower light intensity can give higher molecular weight. In one embodiment, the molecular weight control agent is present at between about 0.025% and about 1%, and particularly between about 0.05% and about 0.5% of the composition.

The miscible blend also includes a reactive diluent that includes a monofunctional (meth)acrylate monomer. The reactive diluent may comprise more than one monomer, for example, from 2-5 different monomers. Examples of these monomers include alkyl (meth)acrylates where the alkyl group contains 1 to 12 carbons if the alkyl group is linear, and up to 30 carbons if the alkyl group is branched (for example, acrylates derived from Guerbet reactions, or β-alkylated dimer alcohols). Examples of these alkyl acrylate include 2-ethylhexyl (meth)acrylate, isooctyl(meth)acrylate, isononyl (meth)acrylate, isodecyl (meth)acrylate, isotridecyl(meth)acrylate, 2-octyl(meth)acrylate, n-butyl(meth)acrylate, isobutyl(meth)acrylate, and the like. Other (meth)acrylates include isobornyl (meth)acrylate, isobornyl (meth)acrylate, tetrahydrofurfuryl (meth)acrylate, tetrahydrofurfuryl (meth)acrylate, alkoxylated tetrahydrofurfuryl (meth)acrylate, and mixtures thereof. For example, the reactive diluent may comprise tetrahydrofurfuryl (meth)acrylate and isobornyl (meth)acrylate. In another embodiment, the reactive diluent may comprise alkoxylated tetrahydrofurfuryl (meth)acrylate and isobornyl (meth)acrylate.

In general, the reactive diluent may be used in any amount depending on other components used to form the adhesive layer as well as the desired properties of the adhesive layer. The adhesive layer may comprise from about 40 wt % to about 90 wt %, or from about 40 wt % to about 60 wt %, of the reactive diluent, relative to the total weight of the adhesive layer. The particular reactive diluent used, and the amount(s) of monomer(s) used, may depend on a variety of factors. For example, the particular monomer(s) and amount(s) thereof may be selected such that the adhesive composition is a liquid composition having a coatable viscosity of from about 100 to about 2000 cps.

The miscible blend that photo-reacts to form the adhesive layer may further comprise a monofunctional (meth)acrylate monomer having alkylene oxide functionality. This monofunctional (meth)acrylate monomer having alkylene oxide functionality may include more than one monomer. Alkylene functionality includes ethylene glycol and propylene glycol. The glycol functionality is comprised of units, and the monomer may have anywhere from 1 to 10 alkylene oxide units, from 1 to 8 alkylene oxide units, or from 4 to 6 alkylene oxide units. The monofunctional (meth)acrylate monomer having alkylene oxide functionality may comprise propylene glycol monoacrylate available as Bisomer PPA6 from Cognis Ltd., Munich, Germany. This monomer has 6 propylene glycol units. The monofunctional (meth)acrylate monomer having alkylene oxide functionality may comprise ethylene glycol monomethacrylate available as Bisomer MPEG350MA from Cognis Ltd. This monomer has on average 7.5 ethylene glycol units.

Optionally, the miscible photo-reactive blend may also comprise a free-radically copolymerizable, multifunctional (meth)acrylate or vinyl crosslinker. Examples of these crosslinkers include 1,4-butanediol di(meth)acrylate, 1,6-hexanedioldi(meth)acrylate, diethyleneglycoldi(meth)acrylate, tetraethyleneglycoldi(meth)acrylate, trimethylolpropanetri(meth)acrylate, divinylbenzene, and the like. The low molecular weight crosslinkers are typically used at levels below 1 wt % of the total photo-reactive blend. More commonly, they are used below 0.5 wt % of the total photo-reactive blend. The copolymerizable crosslinkers may also include (meth)acrylate functional oligomers. These oligomers may comprise any one or more of: a multifunctional urethane (meth)acrylate oligomer, a multifunctional polyester (meth)acrylate oligomer, and a multifunctional polyether (meth)acrylate oligomer. The multifunctional (meth)acrylate oligomer may comprise at least two (meth)acrylate groups, e.g., from 2 to 4 (meth)acrylate groups, that participate in polymerization during curing. The adhesive layer may comprise from about 5 wt % to about 60 wt %, or from about 10 wt % to about 45 wt %, of the one or more multifunctional (meth)acrylate oligomer. The particular multifunctional (meth)acrylate oligomer used, as well as the amount used, may depend on a variety of factors. For example, the particular oligomer and/or the amount thereof may be selected such that the adhesive composition is a liquid composition having a coatable viscosity of from about 100 to about 2000 cps.

The multifunctional (meth)acrylate oligomer may comprise a multifunctional urethane (meth)acrylate oligomer having at least two (meth)acrylate groups, e.g., from 2 to 4 (meth)acrylate groups, that participate in polymerization during curing. In general, these oligomers comprise the reaction product of a polyol with a multifunctional isocyanate, followed by termination with a hydroxy-functional (meth)acrylate. For example, the multifunctional urethane (meth)acrylate oligomer may be formed from an aliphatic polyester or polyether polyol prepared from condensation of a dicarboxylic acid, e.g., adipic acid or maleic acid, and an aliphatic diol, e.g. diethylene glycol or 1,6-hexane diol. In one embodiment, the polyester polyol comprises adipic acid and diethylene glycol. The multifunctional isocyanate may comprise methylene dicyclohexyldiisocyanate or 1,6-hexamethylene diisocyanate. The hydroxy-functional (meth)acrylate may comprise a hydroxyalkyl (meth)acrylate such as 2-hydroxyethyl acrylate, 2-hydroxypropyl (meth)acrylate, or 4-hydroxybutyl acrylate. In one embodiment, the multifunctional urethane (meth)acrylate oligomer comprises the reaction product of a polyester diol, methylene dicyclohexyldiisocyanate, and 2-hydroxyethyl acrylate.

Useful multifunctional urethane (meth)acrylate oligomers include products that are commercially available. For example, the multifunctional aliphatic urethane (meth)acrylate oligomer may comprise urethane diacrylate CN9018, CN3108, and CN3211 available from Sartomer, Co., Exton, Pa., Genomer 4188/EHA (blend of Genomer 4188 with 2-ethylhexyl acrylate), Genomer 4188/M22 (blend of Genomer 4188 with Genomer 1122 monomer), Genomer 4256, and Genomer 4269/M22 (blend of Genomer 4269 and Genomer 1122 monomer) available from Rahn USA Corp., Aurora Ill., and polyether urethane diacrylate BR-3042, BR-3641AA, BR-3741AB, and BR-344 available from Bomar Specialties Co., Torrington, Conn. Additional exemplary multifunctional aliphatic urethane di(meth)acrylates include U-PICA 8967A and U-PICA 8966A urethane diacrylates, available from U-pica, Tokyo, Japan.

The multifunctional (meth)acrylate oligomer may comprise a multifunctional polyester (meth)acrylate oligomer. Useful multifunctional polyester acrylate oligomers include products that are commercially available. For example, the multifunctional polyester acrylate may comprise BE-211 available from Bomar Specialties Co., Torrington, Conn. and CN2255 available from Sartomer Co, Exton, Pa.

The multifunctional (meth)acrylate oligomer may comprise a hydrophobic multifunctional polyether (meth)acrylate oligomer. Useful multifunctional polyether acrylate oligomers include products that are commercially available. For example, the multifunctional polyether acrylate oligomer may comprise Genomer 3414 available from Rahn USA Corp., Aurora, Ill.

Instead of using multifunctional acrylate or vinyl crosslinkers, it is also possible to utilize chemical crosslinking agents, such as multifunctional isocyanates, peroxides, multifunctional epoxides, multifunctional aziridines, melamines, and the like to introduce limited crosslinking during curing of the photo-reactive blend.

The miscible blend includes a free-radical generating initiator and particularly a free-radical generating photoinitiator. Free-radical generating photoinitators are well known to those of ordinary skill in the art and include initiators such as IRGACURE 651, available from BASF, Tarrytown, N.Y., which is 2,2-dimethoxy-2-phenylacetophenone. Also useful is DAROCUR 1173, available from BASF, Mount Olive, N.J., which is 2-hydroxy-2-methyl-1-phenyl-propan-1-one or DAROCUR 4265 which is a blend of 50% Darocur 1173 and 50% 2,4,6-trimethylbenzoyl-diphenyl-phosphine oxide. Photoinitiators can also include benzoin, benzoin alkyl ethers, ketones, phenones, and the like. For example, the adhesive compositions may comprise ethyl-2,4,6-trimethylbenzoylphenylphosphinate available as LUCIRIN TPO-L from BASF Corp. or 1-hydroxycyclohexyl phenyl ketone available as IRGACURE 184 from BASF. The photoinitiator is often used at a concentration of about 0.05 part to 2 parts or 0.05 part to 1 part based on 100 parts of acrylic oligomer and (meth)acrylate monomers in the polymerizable composition (miscible blend). Thermally activated initiators may also be used by themselves or in combination with these photoinitiators. Examples of thermal initiators include organic peroxides, such as benzoylperoxide, and azo compounds, such azo-bis-isobutyronitrile. These thermal initiators would be used in a similar concentration range as the photoinitiators.

To further optimize adhesive performance of the optically clear adhesive, adhesion promoting additives, such as silanes and titanates may also be incorporated into the optically clear adhesives of the present disclosure. Such additives can promote adhesion between the adhesive and the substrates, like the glass and cellulose triacetate of an LCD by coupling to the silanol, hydroxyl, or other reactive groups in the substrate. The silanes and titanates may have only alkoxy substitution on the Si or Ti atom connected to an adhesive copolymerizable or interactive group. Alternatively, the silanes and titanates may have both alkyl and alkoxy substitution on the Si or Ti atom connected to an adhesive copolymerizable or interactive group. The adhesive copolymerizable group is generally an acrylate or methacrylate group, but vinyl and allyl groups may also be used. Alternatively, the silanes or titanates may also react with functional groups in the adhesive, such as a hydroxyalkyl(meth)acrylate. In addition, the silane or titanate may have one or more group providing strong interaction with the adhesive matrix. Examples of this strong interaction include, hydrogen bonding, ionic interaction, and acid-base interaction. An example of a suitable silane includes, but is not limited to, (3-glycidyloxypropyl)trimethoxysilane.

In another embodiment, the adhesive compositions incorporate hydrophilic moieties into the OCA to obtain haze-free optical laminates that remain haze-free even after high temperature/humidity accelerated aging tests. In one aspect, the provided adhesive compositions are derived from precursors that include from about 75 to about 95 parts by weight of an alkyl acrylate having 1 to 14 carbon in the alkyl group. The alkyl acrylate can include aliphatic, cycloaliphatic, or aromatic alkyl groups. Useful alkyl acrylates (i.e., acrylic acid alkyl ester monomers) include linear or branched monofunctional acrylates or methacrylates of non-tertiary alkyl alcohols, the alkyl groups of which have from 1 up to 14 and, in particular, from 1 up to 12 carbon atoms. Useful monomers include, for example, 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, isononyl (meth)acrylate, n-butyl (meth)acrylate, isobutyl (meth)acrylate, hexyl (meth)acrylate, n-nonyl (meth)acrylate, isoamyl (meth)acrylate, n-decyl (meth)acrylate, isodecyl (meth)acrylate, dodecyl (meth)acrylate, isobornyl (meth)acrylate, cyclohexyl (meth)acrylate, phenyl meth(acrylate), benzyl meth(acrylate), and 2-methylbutyl (meth)acrylate, and combinations thereof.

The adhesive composition precursors may also include from about 0 to about 5 parts of a copolymerizable polar monomer such as acrylic monomer containing carboxylic acid, amide, urethane, or urea functional groups. Weak polar monomers like N-vinyl lactams may also be included. A useful N-vinyl lactam is N-vinyl caprolactam. In general, the polar monomer content in the adhesive can include less than about 5 parts by weight or even less than about 3 parts by weight of one or more polar monomers. Polar monomers that are only weakly polar may be incorporated at higher levels, for example 10 parts by weight or less. Useful carboxylic acids include acrylic acid and methacrylic acid. Useful amides include N-vinyl caprolactam, N-vinyl pyrrolidone, (meth)acrylamide, N-methyl (meth)acrylamide, N,N-dimethyl acrylamide, N,N-diethyl meth(acrylamide), N-morpholino acrylate and N-octyl (meth)acrylamide.

The adhesive compositions also include from about 1 to about 25 parts of a hydrophilic polymeric compound based upon 100 parts of the alkyl acrylate and the copolymerizable polar monomer. The hydrophilic polymeric compound typically has a number average molecular weight (Mn) of greater than about 500, or greater than about 1000, or even higher. Suitable hydrophilic polymeric compounds include poly(ethylene oxide) segments, hydroxyl functionality, or a combination thereof. The combination of poly(ethylene oxide) and hydroxyl functionality in the polymer needs to be high enough to make the resulting polymer hydrophilic. By “hydrophilic” it is meant that the polymeric compound can incorporate at least 25 weight percent of water without phase separation. Typically, suitable hydrophilic polymeric compounds may contain poly(ethylene oxide) segments that include at least 10, at least 20, or even at least 30 ethylene oxide units. Alternatively, suitable hydrophilic polymeric compounds include at least 25 weight percent of oxygen in the form of ethylene glycol groups from poly(ethylene oxide) or hydroxyl functionality based upon the hydrocarbon content of the polymer. Useful hydrophilic polymer compounds may be copolymerizable or non-copolymerizable with the adhesive composition, as long as they remain miscible with the adhesive and yield an optically clear adhesive composition. Copolymerizable, hydrophilic polymer compounds include, for example, CD552, available from Sartomer Company, Exton, Pa., which is a monofunctional methoxylated polyethylene glycol (550) methacrylate, or SR9036, also available from Sartomer, that is an ethoxylated bisphenol A dimethacrylate that has 30 polymerized ethylene oxide groups between the bisphenol A moiety and each methacrylate group. Other examples include phenoxypolyethylene glycol acrylate available from Jarchem Industries Inc., Newark, N.J. Other examples of polymeric hydrophilic compounds include poly acrylamide, poly-N,N-dimethylacrylamide, and poly-N-vinylpyrrolidone.

In another aspect, the provided laminates include adhesive compositions derived from precursors that include from about 50 parts by weight to about 95 parts by weight of an alkyl acrylate having 1 to 14 carbon in the alkyl group and from about 0 parts by weight to about 5 parts by weight of a copolymerizable polar monomer. The alkyl acrylate and the copolymerizable polar monomer are described above. The precursors also include from about 5 parts by weight to about 50 parts by weight of a hydrophilic, hydroxyl functional monomeric compound based upon 100 parts of the alkyl acrylate and the copolymerizable polar monomer or monomers. The hydrophilic, hydroxyl functional monomeric compound typically has a hydroxyl equivalent weight of less than 400. The hydroxyl equivalent molecular weight is defined as the molecular weight of the monomeric compound divided by the number of hydroxyl groups in the monomeric compound. Useful monomers of this type include 2-hydroxyethyl acrylate and methacrylate, 3-hydroxypropyl acrylate and methacrylate, 4-hydroxybutyl acrylate and methacrylate, 2-hydroxyethylacrylamide, and N-hydroxypropylacrylamide. Additionally, hydroxy functional monomers based on glycols derived from ethylenoxide or propyleneoxide can also be used. An example of this type of monomer includes an hydroxyl terminated polypropylene glycol acrylate, available as Bisomer PPA 6 from Cognis, Germany. Diols and triols that have hydroxyl equivalent weights of less than 400 are also contemplated for the hydrophilic monomeric compound. In addition to these hydrophilic, hydroxyl functional monomers, ether rich monomers such as ethoxyethoxyethyl acrylate and methoxyethoxyethyl acrylate or their methacrylates can also be used. When used they may substitute all or part of the hydrophilic, hydroxyl functional monomers provide the resulting adhesive remains optically clear, even when exposed to high humidity.

The pressure-sensitive adhesive can be inherently tacky. If desired, tackifiers can be added to the precursor mixture before formation of the pressure-sensitive adhesive. Useful tackifiers include, for example, rosin ester resins, aromatic hydrocarbon resins, aliphatic hydrocarbon resins, and terpene resins. In general, light-colored tackifiers selected from hydrogenated rosin esters, terpenes, or aromatic hydrocarbon resins can be used.

Other materials can be added for special purposes, including, for example, oils, plasticizers, antioxidants, UV stabilizers, pigments, curing agents, polymer additives, and other additives provided that they do not significantly reduce the optical clarity of the pressure sensitive adhesive.

The MS OCA compositions may have additional components added to the precursor mixture. For example, the mixture may include a multifunctional crosslinker. Such crosslinkers include thermal crosslinkers which are activated during the drying step of preparing solvent coated adhesives and crosslinkers that copolymerize during the polymerization step. Such thermal crosslinkers may include multifunctional isocyanates, aziridines, multifunctional (meth)acrylates, and epoxy compounds. Exemplary crosslinkers include difunctional acrylates such as 1,6-hexanediol diacrylate or multifunctional acrylates such as are known to those of skill in the art. Useful isocyanate crosslinkers include, for example, an aromatic diisocyanate available as DESMODUR L-75 from Bayer, Cologne, Germany. Ultraviolet, or “UV”, activated crosslinkers can also be used to crosslink the pressure sensitive adhesive. Such UV crosslinkers may include benzophenones and 4-acryloxybenzophenones.

In addition, the precursor mixtures for the provided MS OCA compositions can include a thermal or a photoinitiator. Examples of thermal initiators include peroxides such as benzoyl peroxide and its derivatives or azo compounds such as VAZO 67, available from E. I. du Pont de Nemours and Co. Wilmington, Del., which is 2,2′-azobis-(2-methylbutyronitrile), or V-601, available from Wako Specialty Chemicals, Richmond, Va., which is dimethyl-2,2′-azobisisobutyrate. A variety of peroxide or azo compounds are available that can be used to initiate thermal polymerization at a wide variety of temperatures. The precursor mixtures can include a photoinitiator. Particularly useful are initiators such as IRGACURE 651, available from BASF, Tarrytown, N.Y., which is 2,2-dimethoxy-2-phenylacetophenone. Typically, the crosslinker, if present, is added to the precursor mixtures in an amount of from about 0.05 parts by weight to about 5.00 parts by weight based upon the other constituents in the mixture. The initiators are typically added to the precursor mixtures in the amount of from 0.05 parts by weight to about 2 parts by weight.

The pressure-sensitive adhesive precursors can be blended to form an optically clear mixture. The mixture can be polymerized by exposure to heat or actinic radiation (to decompose initiators in the mixture). This can be done prior to the addition of a crosslinker to form a coatable syrup to which, subsequently, one or more crosslinkers, and additional initiators can be added, the syrup can be coated on a liner, and cured (i.e., crosslinked) by an addition exposure to initiating conditions for the added initiators. Alternatively, the crosslinker and initiators can be added to the monomer mixture and the monomer mixture can be both polymerized and cured in one step. The desired coating viscosity can determine which procedure used. The disclosed adhesive compositions or precursors may be coated by any variety of known coating techniques such as roll coating, spray coating, knife coating, die coating, and the like. Alternatively, the adhesive precursor composition may also be delivered as a liquid to fill the gap between the two substrates and subsequently be exposed to heat or UV to polymerize and cure the composition.

### Process

The MS OCA and lamination method of the present invention provide point-to-point contact of the MS OCA and a substrate, avoiding air bubble entrapment within the laminate. Over time, the open air channels created by the micro-structures in the MS OCA form into individual bubbles without additional pressure or weight beyond the weight of the substrates. As more time passes, or with the application of heat and or pressure, the individual bubbles also disappear without additional pressure or weight, other than the weight of the substrates.

To create point-to-point lamination, the MS OCA includes features such as protrusions and/or indentations interconnected in at least one dimension in the x, y plane of at least one of its major surfaces, and preferably, in at least two dimensions. The shape and size of these protrusions and/or indentations can be regular or irregular across the surface of the MS OCA. Likewise the interconnection can follow a regular or irregular pattern in at least one dimension in the x, y plane of least one of the major surfaces of the MSOCA The MS OCA allows for trapped bubbles formed during lamination between the MS OCA and a substrate to easily escape, resulting in a bubble-free laminate, in particular after autoclave treatment. As a result, minimum lamination defects are observed after lamination and exposure to time, a process accelerated by autoclave treatment. This is true for pressure-sensitive MS OCAs at room temperature and for heat-activated MS OCAs at the activation temperature or above.

The micro-structures may be formed on the MS OCA by a variety of methods. In one embodiment, the micro-structures are imparted on the OCA by casting on a micro-structured liner. In another embodiment, a smooth liner may be exchanged with a micro-structured liner to emboss the micro-structures when pressure is applied. In another embodiment, a micro-structured tool may be used to emboss the micro-structures onto an exposed surface of the OCA just prior to lamination, or when the OCA is bonded against the second substrate.

The micro-structures of the MS OCA may be formed from micro-structured liners, such as a super shallow liner depicted in FIG. 1, a double feature liner depicted in FIGS. 2a and 2b or the grid liner of FIG. 3. FIG. 1 shows a cross-sectional view of a contact surface of a super shallow liner. The contact surface of the micro-structured liner of FIG. 1 includes interconnected square, quadrangle pyramid features. In one embodiment, each of the pyramid features has a height of between about 5 and 15 microns and a width of between about 150 and about 250 microns. In another embodiment, each of the pyramid features has a height of between about 15 and 100 microns.

FIGS. 2a and 2b show a cross-sectional view of a contact surface of a double feature liner and an enlarged, cross-sectional view of the contact surface of the double feature liner, respectively. The contact surface of the micro-structured liner of FIGS. 2a and 2b includes square quadrangle pyramids and quadrangle pyramid channels. In one embodiment, each of the pyramid features has a height of between about 5 and 15 microns and a width of between about 15 and about 50 microns. In one embodiment, the pyramid creates an angle of between about 100 and about 150 degrees in the corresponding MS OCA. In one embodiment, each of the quadrangle pyramid channels has a depth of between about 10 and about 30 microns and a first width and a second width. In one embodiment, the first width is between about 10 and about 40 microns and the second width is between about 1 micron and about 10 microns. The distance between the respective protrusions or respective indentations is between about 150 and about 250 microns.

FIG. 3 shows a cross-sectional view of a contact surface of a grid pattern liner, the grid pattern being in two (x-y) dimensions. The grid pattern of FIG. 3 is composed of orthogonal walls, having a triangular cross-sectional shape, with a height of about 60 microns and a pitch of about 200 microns. Although the walls are indicated to be orthogonal, i.e. intersecting walls of the grid pattern form a 90° angle, the angle between intersecting walls of the grid pattern can range from 0-90°. At an angle of 0°, the walls no longer form a grid pattern, but a series of parallel rows, in a single (x) dimension. Although the walls of FIG. 3 are shown to have a triangular cross-sectional shape, the shape is not limited and other shapes, e.g. square, rectangle, hemisphere, trapezoid, and the like, may be used. In FIG. 3, the angle opposite the base of the wall is shown to be 40°. This angle is not particularly limited and may range from about 5° to about 150° and is selected in conjunction with the corresponding desired pitch. The pitch can range from about 10 micron, 20 micron, 50 micron or even about 100 micron to about 500 microns, 1,000 microns or even about 5,000 microns. The height of the walls may range from about 5 microns to about 200 microns.

All of the key dimensions, e.g. height, width, shape and spacing, of the micro-structured features of a micro-structured liner are selected based on the final topography desired in the surface of the micro-structured optically clear adhesive. The topography of the surface of the micro-structured optically clear adhesive will have the inverse topography of the micro-structured liner.

Although FIGS. 1, 2a and 2b depict pyramid shapes and FIG. 3 depicts a grid shaped pattern, the contact surface of the micro-structured liners may include any shaped features known to those of skill in the art without departing from the intended scope of the present invention. In addition, the micro-structures do not have to be arranged in a regular or repeating pattern, such as lines or a cross pattern. The micro-structures may also be in a random pattern.

In practice, the MS OCA can be formed by first preparing a PSA polymer solution or hot melt and coating onto a micro-structured liner. In one embodiment, the solution is coated using a knife coater. The solution coated on the liner is then dried in an oven. In one embodiment, the solution is dried at about 100° C. for about 10 minutes. The resulting PSA may then be laminated with a release liner, creating an adhesive transfer tape. In a second embodiment the adhesive is hot melt coated on the micro-structured liner. In a third embodiment the MS OCA precursor is coated on the liner, and polymerized in bulk on its surface.

In a typical application of the MS OCA composition for rigid-to-rigid (e.g., cover glass to touch sensor glass lamination for use in a phone or tablet device) lamination, the lamination is first carried out at either room or elevated temperature. In one embodiment, lamination is carried out at between about 20° C. and about 60° C. At the lamination temperature, the adhesive composition has a tan delta value of at least 0.3, particularly at least 0.5 and more particularly at least 0.7. When the tan delta value is too low (i.e., below 0.3), initial wet out of the adhesive may be difficult and higher lamination pressure and/or longer press times may be required to achieve good wetting. This may result in longer cycle times and possible distortion of one or more of the display substrates. When the tan delta is too low, the adhesive also retains significant elastic character and it may be more difficult to completely erase the micro-structure that was present at initial lamination. A higher tan delta value allows for more viscous character in the MS OCA, providing an opportunity to fill the micro-structure more completely prior to crosslinking of the adhesive instead of having to rely on elastic memory to try to remove the micro-structure after lamination.

A laminate 100, as shown in FIGS. 4a and 4b, is prepared by removing the release liner (not shown) from a first major surface 32, a non-micro-structured surface, of the MS OCA 30. The first major surface of the MS OCA is then applied to a first substrate 10. In one embodiment, the MS OCA is applied to the first substrate using a rubber roller. A micro-structured liner (not shown) is then removed from the second major surface 34 of the MS OCA, exposing a micro-structured surface, and the second major surface of the MS OCA is applied to a second substrate 20. Upon application, point-to-point contact is formed between the repeated micro-structure units 36 of the micro-structured surface and the second substrate, forming a bond line 50, which extends between the first and second substrates. The bond line contains regions of open air space 40.

The second major surface, of either the non-crosslinked or lightly crosslinked MS OCA, wets the second substrate gradually as the second substrate is contacted with the micro-structured surface of the MS OCA. Uniform spreading of the MS OCA then proceeds, increasing the contact area and decreasing the area of open air space. The continuous, open air space then begins to close in to form individual bubbles. As time passes, the individual bubbles also decrease in size until any air space is substantially removed from the bond line, FIG. 4b. Lamination may be considered complete when there is wet-out to the point where a pattern caused by the micro-structures is no longer visible to the naked eye and there is no Moire in the display. Further crosslinking of the MS OCA can be completed at that point, if so desired. In one embodiment, lamination is completed within 72 hours, within 48 hours, within 24 hours, within 20 hours, within 18 hours and within 3 hours. Defect-free lamination can thus occur under vacuumless lamination with no pressure except for the weight of the second substrate.

If desired, the laminate can also be subjected to pressure and/or heat to remove any trapped bubbles during the rigid-to-rigid lamination process. In one embodiment, the laminate is treated in an autoclave where pressure and temperature (e.g., 5 atmosphere pressure and 60 to 100° C.) are applied to remove any remaining trapped bubbles. Good adhesive flow allows for the trapped bubbles from the lamination step to easily escape the adhesive matrix, resulting in a bubble-free laminate after the autoclave treatment. When subjected to increased pressure and/or heat, the amount of time required to complete lamination can decrease substantially. In one embodiment, when subjected to increased pressure and/or heat, lamination is completed in less than one hour, particularly less than 30 minutes and more particularly less than 20 minutes.

Under autoclave temperatures, the MS OCA has the same tan delta values for the range of temperatures in common use (i.e., 40 to 70° C.). When the tan delta values at typical autoclave temperatures falls below 0.3, the adhesive may not soften fast enough to further wet the substrate and to allow any lamination step entrapped air bubbles to escape. Excessive flow may not be desirable. For example if the tan delta value exceeds about 1.5, the viscous character of the adhesive may be too high and adhesive squeeze-out and oozing may result, especially under higher pressure. By reducing the temperature, tan delta can be decreased and good lamination without squeeze-out or oozing can be obtained. Thus the combined benefits of good substrate wetting and easy bubble removal enable an efficient lamination display assembly process with greatly shortened cycle time.

### APPLICATIONS

In one exemplary application, the articles and the method of making the articles described in the present disclosure can be integrated into electronic devices such as, but not limited to: TV LCD panels, active signage displays, cell phones, hand held gaming devices, navigation systems, tablet PCs, and laptop computers. The articles and methods of making the articles can also be used in non-optical applications which require bubble-free lamination but do not need to be optically clear. For example, the articles and methods described can be used in devices such as, but not limited to, track pads and lap tops.

In some embodiments, the optical assembly includes a liquid crystal display assembly wherein the display panel includes a liquid crystal display panel. Liquid crystal display panels are well known and typically include a liquid crystal material disposed between two substantially transparent substrates such as glass or polymer substrates. As used herein, substantially transparent refers to a substrate that has, per millimeter thickness, a transmission of greater than about 85% at 400 nm, greater than about 90% at 530 nm and greater than about 90% at 670 nm. On the inner surfaces of the substantially transparent substrates are transparent electrically conductive materials that function as electrodes. In some cases, on the outer surfaces of the substantially transparent substrates are polarizing films that pass essentially only one polarization state of light. When a voltage is applied selectively across the electrodes, the liquid crystal material reorients to modify the polarization state of light, such that an image is created. The liquid crystal display panel may also include a liquid crystal material disposed between a thin film transistor (TFT) array panel having a plurality of TFTs arranged in a matrix pattern and a common electrode panel having a common electrode.

In some embodiments, the optical assembly includes a plasma display assembly wherein the display panel includes a plasma display panel. Plasma display panels are well known and typically include an inert mixture of noble gases such as neon and xenon disposed in many tiny cells located between the two glass panels. Control circuitry charges electrodes within the panel cause the gases to ionize and form a plasma which then excites phosphors to emit light.

In some embodiments, the optical assembly includes an organic electroluminescent assembly wherein the display panel includes an organic light emitting diode or light emitting polymer disposed between two glass panels.

Other types of display panels can also benefit from display bonding, for example, electrophoretic displays having touch panels such as those used in electronic paper displays.

The optical assembly also includes a substantially transparent substrate that has, per millimeter thickness, a transmission of greater than about 85% at 400 nm, greater than about 90% at 530 nm and greater than about 90% at 670 nm. In a typical liquid crystal display assembly, the substantially transparent substrate may be referred to as a front or rear cover plate. The substantially transparent substrate may include glass or polymer. Useful glasses include borosilicate, soda-lime, and other glasses suitable for use in display applications as protective covers. Useful polymers include, but are not limited to polyester films such as PET, polycarbonate films or plates, acrylic plates and cycloolefin polymers, such as Zeonox and Zeonor available from Zeon Chemicals L.P. The substantially transparent substrate particularly has an index of refraction close to that of the display panel and/or the photopolymerizable layer. For example, between about 1.45 and about 1.55. The substantially transparent substrate typically has a thickness of from about 0.5 to about 5 mm.

In some embodiments, the substantially transparent substrate includes a touch screen. Touch screens are well known in the art and generally include a transparent conductive layer disposed between two substantially transparent substrates. For example, a touch screen may include indium tin oxide disposed between a glass substrate and a polymer substrate.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

### Test Methods

### Molecular Weight Measurements

The weight average molecular weight of each of the PSAs was determined using conventional gel permeation chromatography (GPC) techniques with tetrahydrofuran as solvent and polystyrene standards. The measurement was performed using a 1200 series HPLC system with 2× PLgel MIXED-B columns (Agilent Technologies, California, USA) and Optilab rEX detector (Wyatt Technology Corporation, Santa Barbara, Calif.). Sample concentration was approximately 0.1% (w/w) in THF, and was delivered at a flow rate of 1.0 ml/min with an injection volume of 100 μl.

### Dynamic Mechanical Analysis (DMA) Measurements

DMA measurements were made on ARES Rheometer, manufactured by TA Instruments, Delaware, USA. Testing was conducted using parallel plate geometry. The adhesive sample thickness was about 3 mm and was achieved by stacking the appropriate number of layers of non-micro-structured adhesive transfer tape. The temperature ramp was from −40° C. to 200° C. The frequency of perturbation was 1 Hz. The Tg was taken as temperature of the Tan 6 peak. This test also provides values for shear storage modulus (G′), shear loss modulus (G″), and tan delta (i.e. G″/G′)

### Gel Content

The gel fraction, based on weight, was determined using conventional extraction techniques using methyl ethyl ketone (MEK) as solvent. One gram of PSA was dissolved in 40 g of MEK and shaken for 20 hours at room temperature. The solution was filtered through filter paper, available under the trade designation “WHATMAN Grade 40” from Whatman Plc, Kent, UK. Insoluble constituent on the filter was dried for 60 minutes at 100° C. The mass of the dried insoluble constituents was weighed and the gel fraction was calculated from the following formula:

Gel Content(%)=(Mass of insoluble constituent/Mass of the initial adhesive)×100.

### Wetting Behavior

The wetting behavior of various micro-structured optically clear adhesive transfer tapes (MS-OCA-TT) on glass was observed using an optical microscope. Two glass substrates were laminated together using a MS-OCA-TT as follows. A piece of MS-OCA-TT, about 40 mm×85 mm, was cut and laminated to the center of a float glass plate, about 55 mm×85 mm×0.55 mm, using a rubber roller, such that the longest dimensions of the MS-OCA-TT and float glass plate aligned. In this lamination step, the non-microstructured liner was removed and the non-micro-structured adhesive surface was laminated to the float glass plate. The micro-structured liner of the MS-OCA-TT was removed and a microscope cover glass (24 mm×32 min×0.15 mm) was gently placed on the exposed microstructured adhesive surface. The cover glass was positioned such that it aligned with the center of the float glass plate. The laminate was placed in the microscope stage and the wetting behavior was monitored, at the center of the cover glass, as a function of time.

### 180° Peel Strength

180° peel strength was measured on an Autograph AG-X tensile testing machine available from Shimadzu Corporation, Kyoto, Japan. The peel rate was 300 mm/min. Samples for peel strength measurement were prepared as follows. RL1 was removed from the optically clear adhesive transfer tape (OCA-TT). The exposed adhesive was hand laminated to a piece of T60 Film using a rubber roller. The T-60 Film/adhesive laminate was cut into strips of about 100 mm length×25 mm width. Depending on which OCA-TT was used, micro-structured liner 1 (MS-L1) or RL2 was removed from the T-60 Film/adhesive laminate. The exposed adhesive surface was laminated to the surface of a 50 mm×80 mm×0.7 mm glass plate, available under the trade designation “EAGLE2000” from Corning Incorporated, Corning, N.Y. A rubber roller, having a mass of about 100 g, was rolled across the T60 Film/adhesive strip at a speed of about 300 mm/min to laminate the T-60 Film/adhesive strip to the glass plate. The 180° peel strength test was conducted 3 minutes after lamination. The 180° peel strength test was conducted on another prepared sample one hour after lamination. In some cases, an additional peel strength test was conducted on a sample 24 hours after lamination.

### Materials Used

Materials

| Abbreviation or | |
|---|---|
| Trade Name | Description |
| 2-EHA | 2-Ethylhexyl acrylate |
| NOA | n-Octyl acrylate |
| ISTA | Isostearyl acrylate, available from Osaka Organic |
| | Chemical Industry, Ltd., Osaka, Japan |
| LMA | Lauryl methacrylate |
| AA | Acrylic acid |
| 4-HBA | 4-Hydroxybutyl acrylate |
| AEBP | 4-Acryloyloxyethoxybenzophenone |
| K-AOI | 2-Acryloyloxyethyl isocyanate, available under |
| | the trade designation “KARENZ AOI” from Showa |
| | Denko K.K., Tokyo, Japan. |
| TPO | 2,4,6-Trimethylbenzoyldiphenylphosphine oxide, |
| | available under the trade designation “Lucirin TPO” |
| | from BASF Corporation, Florham Park, New Jersey. |
| Irg651 | 2,2-Dimethoxy-1,2-diphenylethan-1-one, available |
| | under the trade designation “IRGACURE 651” from |
| | BASF Corporation, Florham Park, New Jersey. |
| V-65 | Thermal initiator, 2,2′-Azobis(2,4-dimethyl |
| | valeronitrile, available under the trade designation |
| | “V-65” from Wako Pure Chemical Industries, Ltd., |
| | Osaka, Japan. |
| RL1 | A release liner (non-microstructured) available |
| | under the trade designation “FILMBYNA 38E- |
| | 0010BD” from Fujimori Kogyo Co., LTD., Tokyo, |
| | Japan. |
| RL2 | A 50 micron thick PET release liner (non-micro- |
| | structured) available under the trade designation |
| | “CERAPEEL MIB(T)” from Toray Advanced Film |
| | Co., Ltd., Tokyo, Japan. |
| T60 Film | A 25 micron thick corona-treated polyester film |
| | available under the trade designation “LUMIRROR |
| | T60” Toray Industries Inc., Tokyo Japan. |

### Micro-Structured Liner 1 (MS-L1)

MS-L1 consisted of a series of V-shaped channels orthogonal to one another, forming an x-y grid type pattern, having a pitch of about 197 microns and a depth of about 13 microns. A cross-sectional view of MS-L1 is shown in FIG. 1. The resulting channels formed a topography comprising a series of square, four-sided pyramids having a base of about 197 microns and a height of about 13 microns. The liner was prepared by a micro-embossing technique known in the art, see for example U.S. Pat. No. 6,524,675 (Mikami et. al.) and U.S. Pat. No. 5,897,930 (Calhoun et. al.).

### Micro-Structured Liner 2 (MS-L2)

A diagram of the cross-section of MS-L2 is shown in FIGS. 2a and 2b. This is a double feature liner which includes a V-shaped indention or hollow of about 38 microns at its base and has a depth of about 10 microns. In 3-dimensions, the indention is actually a four-sided pyramid having a base of about 38 microns and a depth of about 10 microns. The indention repeats in a square array on the top of the truncated, four-sided pyramids, also in a square array, having a base of about 194 microns and a channel width between pyramids of about 3 microns. The liner was prepared by a micro-embossing technique known in the art, see for example U.S. Pat. No. 6,524,675 (Mikami et. al.) and U.S. Pat. No. 5,897,930 (Calhoun et. al.).

### Micro-Structured Liner 3 (MS-L3)

MS-L3 was identical to MS-L1, except the depth of the channels was about 60 microns and the width of the channels was about 120 microns. The resulting channels formed a topography comprising a series of square, four-sided pyramids having a base of about 120 microns and a depth of about 60 microns. The liner was prepared by a micro-embossing technique known in the art, see for example U.S. Pat. No. 6,524,675 (Mikami, et. al.) and U.S. Pat. No. 5,897,930 (Calhoun, et. al.).

### Micro-Structured Liner 4 (MS-L4)

MS-L4 consisted of a series of walls orthogonal to one another, forming a grid pattern. The walls had a triangular cross-section having a height of about 60 microns and the included angle, opposite the base, was 40°, FIG. 3. The pitch, i.e. distance between walls, was about 200 microns. The liner was prepared by a micro-embossing technique known in the art, see for example U.S. Pat. No. 6,524,675 (Mikami, et. al.) and U.S. Pat. No. 5,897,930 (Calhoun, et. al.).

### Preparation of Pressure Sensitive Adhesive Polymer Solutions

### Pressure Sensitive Adhesive Solution 1 (PSA-S1)

PSA-S1, an acrylic copolymer containing an acrylic acid ester having an UV-crosslinkable site, was prepared by mixing, on a weight basis, 37.5 parts 2-EHA, 50.0 parts ISTA, 12.5 parts AA and 0.95 parts AEBP. AEBP is the acrylic acid ester having the UV-crosslinkable site. The mixture was diluted with a mixed solvent of ethyl acetate (EtOAc)/MEK, yielding a monomer concentration of 45% by weight. The weight ratio of EtOAc/MEK was 20/80. V-65 initiator was added to the solution at 0.2 parts by weight based on the weight of monomer components. The solution was nitrogen-purged for 10 minutes. The polymerization reaction was allowed to proceed in a constant temperature bath at 50° C. for 24 hours. A transparent, viscous solution was obtained, PSA-S1. After solvent removal, the weight average molecular weight, M_{w}, of the recovered PSA, PSA-1, was about 210,000 g/mol and the Tg was about 38° C. At room temperature, PSA-1 is considered to be a “stiff”, “high modulus”, “slow flow”, optically clear PSA.

### Pressure Sensitive Adhesive Solution 2 (PSA-S2)

PSA-S2 was prepared by mixing, on a weight basis, 80.55 parts NOA, 10.0 parts LMA, 7.5 parts AA, 1.6 parts 4-HBA and 0.35 parts AEBP. The mixture was diluted with a mixed solvent of EtOAc/Toluene, yielding a monomer concentration of 45% by weight. The weight ratio of EtOAc/Toluene was 50/50. The polymerization reaction was allowed to proceed in a constant temperature bath at 50° C. for 24 hours. A transparent, viscous solution was obtained, PSA-S2. After solvent removal, the M_{w} of the recovered PSA, PSA-2, was about 400,000 g/mol and the Tg was about −15° C. At room temperature, PSA-2 is considered to be a “soft”, “low modulus”, “flowable” optically clear PSA.

### Pressure Sensitive Adhesive Solution 3 (PSA-S3)

PSA-3 was an acrylic copolymer having an UV-crosslinkable site. PSA-S3 was prepared by mixing, on a weight basis, 80.9 parts NOA, 10.0 parts LMA, 7.5 parts AA and 1.6 parts 4-HBA. The mixture was diluted with a mixed solvent of ethyl acetate (EtOAc)/MEK, yielding a monomer concentration of 35%. The weight ratio of EtOAc/MEK was 50/50. Further, V-65 was added to the monomer/solvent mixture at 0.2 weight %, based on the weight of monomers, and the system was nitrogen-purged for 10 minutes. The polymerization reaction was allowed to proceed in a constant temperature bath at 50° C. for 24 hours. A transparent, viscous solution was obtained. A small sample was taken. After solvent removal from the sample, the M_{w} of the recovered psa was 400,000 g/mol. To the remaining psa solution was added K-AOI, 0.15 weight % based on the weight of psa in solution, and TPO, 0.3 weight % based on the weight of psa in solution. The solution was mixed at room temperature for 24 hours, producing PSA-S3.

### Pressure Sensitive Adhesive Solution 4 (PSA-S4)

PSA-S4 was prepared by mixing, on a weight basis, 90.0 parts NOA, 10.0 parts LMA, 10.0 parts AA and 0.2 parts Irg651 in a glass vessel. The monomer mixture was purged with nitrogen. The mixture was then partially polymerized, by exposing the mixture to ultraviolet irradiation via a low-pressure mercury lamp for a few minutes, producing a viscous liquid having a viscosity of about 1,100 mPa·s. To this liquid were added 0.2 weight % AEBP and 0.1 weight % Irg651, based on the weight of viscous liquid. The mixture was thoroughly stirred, producing PSA-S4, which is a pre-polymer syrup.

### Preparation of Adhesive Transfer Tapes

### Microstructured (MS) Optically Clear Adhesive (OCA) Transfer Tape (TT) 1

MS-OCA-TT-1 was prepared by coating PSA-S1 on MS-L1 using a conventional knife coater. After coating, the adhesive was dried in an oven at 100° C. for 10 minutes. The thickness of the PSA after drying was about 75 microns. Subsequently, the exposed adhesive surface was laminated to a release liner, RL1, forming MS-OCA-TT-1.

### MS-OCA-TT-2

MS-OCA-TT-2 was prepared similarly to that of MS-OCA-TT-1 except PSA-S1 was coated on MS-L2. The adhesive solution was coated such that the protrusion of MS-L2 protruded into the adhesive solution. After drying, the exposed adhesive surface was laminated to RL1, forming MS-OCA-TT-2. The thickness of the PSA after drying was about 75 microns.

### MS-OCA-TT-3

MS-OCA-TT-3 was prepared similarly to MS-OCA-TT-1 except that PSA-S2 was used in place of PSA-S1. After drying, the exposed adhesive surface was laminated to RL1 forming an MS-OCA-TT-3. The thickness of the PSA after drying was about 75 microns.

### MS-OCA-TT-4

MS-OCA-TT-4 was prepared similarly to MS-OCA-TT-1 except that PSA-S3 was used in place of PSA-S1 and MS-L4 was used in place of MS-L1. After drying, the exposed adhesive surface was laminated to RL1 forming an MS-OCA-TT-4. The thickness of the PSA after drying was about 100 microns.

### MS-OCA-TT-5

MS-OCA-TT-5 was prepared by on-web polymerization. PSA-S4, a pre-polymer syrup, was coated on MS-L3, and was laminated to RL1. Then, the pre-polymer syrup was polymerized by irradiating with a low-pressure mercury lamp, at an intensity of about 2 mW/cm² for 45 seconds, followed by irradiating both sides of the adhesive between liners for an additional 45 seconds at an intensity of about 6 mW/cm², producing MS-OCA-TT-5. The thickness of the PSA was about 150 microns.

### MS-OCA-TT-6

MS-OCA-TT-6 was prepared similarly to MS-OCA-TT-1 except that PSA-S3 was used in place of PSA-S1. After drying, the exposed adhesive surface was laminated to RL1 forming an MS-OCA-TT-6. The thickness of the PSA after drying was about 100 microns.

### Non-Micro-Structured (NMS) Optically Clear Adhesive (OCA) Transfer Tape (TT) A

NMS-OCA-TT-A, i.e., a conventional transfer tape having a flat adhesive surface, i.e. non-micro-structured adhesive surface, was prepared similarly to MS-OCA-TT-1 except that PSA-S1 was coated on the heavy release side of RL2. After drying, the exposed adhesive surface was laminated to RL1, forming NMS-OCA-TT-A. The thickness of the PSA after drying was about 75 microns.

### NMS-OCA-TT-B

NMS-OCA-TT-B was prepared similarly to NMS-OCA-TT-A except that PSA-S2 was used in place of PSA-S1. After drying, the exposed adhesive surface was laminated to RL1, forming NMS-OCA-TT-B. The thickness of the PSA after drying was about 75 microns.

### NMS-OCA-TT-C

NMS-OCA-TT-C was prepared similarly to NMS-OCA-TT-A except that PSA-S3 was used in place of PSA-S1. After drying, the exposed adhesive surface was laminated to RL1, forming NMS-OCA-TT-C. The thickness of the PSA after drying was about 100 microns.

### NMS-OCA-TT-D

NMS-OCA-TT-D was prepared similarly to MS-OCA-TT-5 except that MS-L3 was replaced by RL2, PSA-4, a pre-polymer syrup, being coated on the heavy release side of RL2. The thickness of the PSA after curing was about 150 microns.

### Crosslinked MS-OCA-TT

MS-OCA-TTs, with varying degrees of crosslinking, were prepared by taking MS-OCA-TT-1 and MS-OCA-TT-2 and crosslinking the adhesive via UV curing. Crosslinking was conducted by UV light irradiation using a model F-300, UV curing system having a H-bulb, with a lamp power of 120 W/cm, available from Fusion UV Systems, Japan. Three samples each of MS-OCA-TT-1 and MS-OCA-TT-2, having different cross-linking density, were prepared by changing irradiation time. For a given MS-OCA-TT, the three samples were exposed to a total energy per area of 400, 1,000, 3,000 mJ/cm², respectively. The total UV energy was measured by a UV POWER PUCK® II available from EIT, Inc., Sterling, Va.

As a relative measure of the degree of crosslinking, the gel content of MS-OCA-TT-1, before and after UV irradiation was measured. Results are shown in Table 1.

TABLE 1
Gel Content (%) of MS-OCA-TT-1 Adhesive

| UV Energy (mJ/cm²) | Gel Content (%) |
|---|---|
| 0 | 1.1 |
| 400 | 1.5 |
| 1,000 | 28.2 |
| 3,000 | 70.0 |

Using the wetting behavior test method described above, the wetting behavior of MS-OCA-TT-1, as fabricated and with additional crosslinking via UV irradiation, was examined. FIG. 5 shows the wetting behavior as a function of time and additional UV exposure.

As shown in FIG. 5, non-crosslinked MS-OCA-TT-1 and lightly cross-linked MS-OCA-TT-1, samples with 400 and 1,000 mJ/cm² additional UV irradiation, respectively, wetted the cover glass gradually by contacting the micro-structured surface of the MS OCA. A point-to-point contact at each micro-structured repeat unit was first formed. Uniform spreading followed. Next, the continuous, open channels formed by the micro-structures formed into individual bubbles. Eventually, the individual bubbles became smaller and disappeared. Through this processes, a defect-free lamination was produced using a vacuumless lamination process, without the aid of additional pressure, except for the weight of the cover glass. On the other hand, the highly crosslinked MS OCA, with 3,000 mJ/cm² additional UV irradiation, did not wet the cover glass. The original surface structure remained 6 days after the cover glass originally contacted the micro-structured adhesive surface.

As shown in FIG. 6, the wetting behavior of MS-OCA-TT-2 was similar to that of MS-OCA-TT-1, following a similar wetting mechanism.

As shown in FIG. 7, the wetting behavior of MS-OCA-TT-3 (without additional UV irradiation), as a function of time, follows a similar mechanism to that of MS-OCA-TT-1. However, the required time for MS-OCA-TT-3 to completely wet the cover glass was substantially less than that of MS-OCA-TT-1, being about 3 hours compared to between about 5 and about 18 hours for MS-OCA-TT-1. MS-OCA-TT-3 is the softer, lower modulus, lower Tg (below room temperature) adhesive compared to MS-OCA-TT-1 and it was thought that these factors contributed to the faster wetting behavior.

Example 1, Example 2, Comparative Example 3 and Comparative Example 4 examined the effect of adhesive micro-structure surface and adhesive type on the adhesive wetting characteristics in a “rigid-to rigid” lamination of two glass plates. The laminate was fabricated using a vacuumless lamination process followed by a final autoclaving step.

### Example 1

MS-OCA-TT-1 was laminated between two glass panels using a vacuumless lamination procedure. A piece of MS-OCA-TT-1, 200 mm×120 mm, was laminated to a 220 mm×125 mm×0.70 mm glass plate, available under the trade designation “EAGLE2000” from Corning Incorporated, Corning, N.Y. RL1 was removed from MS-OCA-TT-1 and the flat adhesive surface was hand laminated to the glass plate using a rubber roller such that the length and width dimensions of the tape and plate coincided. Next, MS-L1 was removed from the tape and a 50 mm×80 mm×0.7 mm glass plate, available under the trade designation “EAGLE2000” from Corning Incorporated, was gently placed on the exposed, micro-structured adhesive surface. The laminate was allowed to sit for 1 day at ambient conditions. The wetting behavior was observed visually and is documented in Table 2. The laminate was placed in an autoclave, model number 29381 available from Kurihara Manufactory, Tokyo, Japan. The laminate was autoclaved at room temperature and 250 kPa pressure for 30 minutes. The sample was removed from the autoclave and the wetting characteristics were visually observed. The results are noted in Table 2.

### Comparative Example A

NMS-OCA-TT-A was laminated between two glass plates following the procedure described in EXAMPLE 1, with NMS-OCA-TT-A replacing MS-OCA-TT-1. RL1 was removed for lamination to the first glass plate and RL2 was removed for lamination to the second glass plate. The wetting behavior before and after the autoclave treatment was visually observed with observations noted in Table 2.

### Example 2

MS-OCA-TT-2 was laminated between two glass plates following the procedure described in EXAMPLE 1, with NMS-OCA-TT-3 replacing MS-OCA-TT-1. RL1 was removed for lamination to the first glass plate and MS-L2 was removed for lamination to the second glass plate. The wetting behavior before and after the autoclave treatment was visually observed with observations noted in Table 2.

### Comparative Example B

NMS-OCA-TT-B was laminated between two glass plates following the procedure described in EXAMPLE 1, with NMS-OCA-TT-B replacing MS-OCA-TT-1. RL1 was removed for lamination to the first glass plate and RL2 was removed for lamination to the second glass plate. The wetting behavior before and after the autoclave treatment was visually observed with observations noted in Table 2.

As can be seen in Table 2, the NMS-OCAs tended to trap bigger size air bubbles, which were generally more difficult to remove via the autoclave treatment. By contrast, the MS-OCAs wetting behavior started from a point-to-point contact between the glass and adhesive at nearly each micro-structured feature. The wetted regions of the glass spread uniformly, as previously described. Therefore, smaller size air bubbles were formed uniformly throughout the laminate. These smaller, more uniformly located bubbles were generally easier to remove via the autoclave treatment.

TABLE 2

| | Wetting Behavior | |
|---|---|---|
| Sample | Before Autoclave | After Autoclave |
| Example 1 | Uniform, small air bubbles | No air bubbles |
| Comparative | Non-uniform, large air bubbles | No air bubbles |
| Example A | | |
| Example 2 | Uniform, small air bubbles | No air bubbles |
| Comparative | Non-uniform, large air bubbles | Air bubbles remained |
| Example B | | |

Example 3, Example 4, Comparative Example C and Comparative Example D examined the effect of adhesive micro-structure surface and adhesive type on the adhesion of the adhesive to a glass plate as a function of contact time between the adhesive and glass plate.

### Example 3

Using the lamination procedure described in the 180° peel strength test method, laminates were made from MS-OCA-TT-1, forming Example 3. 180° peel strength test results are shown in Table 3.

### Comparative Example C

Using the lamination procedure described in the 180° peel strength test method, laminates were made from NMS-OCA-TT-A, forming Comparative Example C. 180° peel strength test results are shown in Table 3.

### Example 4

Using the lamination procedure described in the 180° peel strength test method, laminates were made from MS-OCA-TT-3, forming Example 4. 180° peel strength test results are shown in Table 3.

### Comparative Example D

Using the lamination procedure described in the 180° peel strength test method, laminates were made from NMS-OCA-TT-B, forming Comparative Example D. 180° peel strength test results are shown in Table 3.

TABLE 3

| | Peel Strength (N/25 mm) at Various | | |
|---|---|---|---|
| | Times After Lamination | | |
| | 3 minutes | 1 hour | 24 hours |
| Example 3 | 0.12 | 1.25 | 15.7 (anchor failure*) |
| Comparative Example C | 0.7 | 1.5 | 14.7 (anchor failure*) |
| Example 4 | 17.8 | 20.1 | — |
| Comparative Example D | 18.2 | 20.8 | — |

*anchor failure indicates failure between the adhesive and the T60 film backing.

The data in Table 3 indicates that the laminate prepared from the MS-OCA-TT-1 (Example 3) had lower initial peel strength (strength at 3 minutes) compared to the laminate prepared from the NMS-OCA-TT-A (Comparative Example C). It is believed that the low peel strength of Example 3 may make it a reworkable adhesive after initial lamination. Additionally, it is capable of forming bubble free laminates using a vacuumless lamination process in conjunction with a final autoclave step. Although Comparative Example C has relatively low initial peel strength, its peel strength is at least a factor of five times greater than that of Example 3 and is believed not to be reworkable.

The data in Table 3 also shows that the laminate prepared from MS-OCA-TT-3 (Example 4) had similar initial peel strength (strength at 3 minutes) compared to the laminate prepared from NMS-OCA-TT-B (Comparative Example D). Although both adhesives show high peel strength, MS-OCA-TT-3 had the added advantage of being capable of forming bubble free laminates using a vacuumless lamination process in conjunction with a final autoclave step (see Table 2, Example 2), whereas NMS-OCA-TT-B did not form bubble free laminates (see Table 2, Comparative Example B). The difference in peel strength between adhesives formed from the higher Tg adhesive, PSA-1 (Example 3 and Comparative Example C), and the lower Tg adhesive, PSA-2 (Example 4 and Comparative Example D), is substantial in the early time periods after lamination, with the lower Tg adhesive exhibiting significantly higher adhesion.

### Example 5

MS-OCA-TT-4 was laminated between two glass panels. One of the glass panels had an ink step, i.e. topography. The glass panel with ink step was an 80 mm×55 mm×0.7 mm piece of float glass that had a 20 micron thick×6 mm wide ink step printed around the entire length of its perimeter. The lamination procedure is as follows. A piece of MS-OCA-TT-4, 100 mm×70 mm, was first laminated to a 72 mm×47 mm×0.70 mm glass plate. RL1 was removed from MS-OCA-TT-4, and the flat adhesive surface was hand laminated to the glass plate using a rubber roller such that the length and width dimensions of the tape and plate coincided. Next, MS-L4 was removed from MS-OCA-TT-4 and the glass plate with an ink-step was gently placed on the exposed micro-structured adhesive surface. A few minutes later, the laminate was pressed with a 2 kg roller for 3 cycles. The contact and wetting of the micro-structured surface of the MS-OCA-TT-4 in the interior of the ink-step region started before the continuous (open) air space of the micro-structured adhesive in the ink-step region changed to independent bubbles via the flowing of the MS-OCA-TT-4. The laminate was then placed in an autoclave, model number 29381 available from Kurihara Manufactory, Tokyo, Japan. The laminate was autoclaved at 60° C. and 500 kP pressure for 30 minutes. The sample was removed from the autoclave and the lamination performance was visually observed. The results are noted in Table 4.

After visual observation, the laminate made in the Example 5 was used for reliability testing at elevated temperature and humidity. First, UV crosslinking of the OCA was conducted as follows: UV light was irradiated on the laminate through the glass plate with the ink-step using a Fusion UV model F-300 (H-bulb, 120 W/cm) available from Fusion Systems Japan KK, Tokyo, Japan. The total UV energy, measured by a “UV POWER PUCK II”, available from EIT, Inc., Sterling, Va., was 2261 mJ/cm² for UV-A (320-390 nm) and 1615 mJ/cm² for UV-B (280-320 nm) and 222 mJ/cm² for UV-C (250-260 nm). Next, the laminate was placed in a constant temperature and humidity chamber. The aging conditions were 65° C. and 90% relative humidity for 3 days. After aging treatment, visual inspection of the laminate indicated that the laminate was defect free with no bubbles being observed.

### Example 6

MS-OCA-TT-5 was laminated between two glass panels; one of the glass panels had an ink step, i.e. topography, as described in Example 5. MS-OCA-TT-5 was laminated following the procedure of Example 5, with MS-OCA-TT-5 replacing MS-OCA-TT-4. RL1 was removed for lamination to the flat glass plate and MS-L3 was removed for lamination to the glass plate with ink-step. The contact and wetting of the micro-structured surface of the MS-OCA-TT-5 in the interior of the ink-step region started before the continuous (open) air space of the micro-structured adhesive in the ink-step region changed to independent bubbles via the flowing of the MS-OCA-TT-5. The lamination performance after the autoclave treatment was visually observed with observations noted in Table 4.

After visual observation, the laminate made in the Example 6 was used for reliability testing at elevated temperature and humidity. After crosslinking and aging at elevated temperature and humidity, as described in Example 5, visual inspection of the laminate indicated that the laminate was defect free with no bubbles being observed.

### Comparative Example E

MS-OCA-TT-6 was laminated between two glass panels; one of the glass panels had an ink step, i.e. topography, as described in Example 5. MS-OCA-TT-6 was laminated following the procedure of Example 5, with MS-OCA-TT-6 replacing MS-OCA-TT-4. RL1 was removed for lamination to the flat glass plate and MS-L1 was removed for lamination to the glass plate with ink-step. In this comparative example, the contact and wetting of the micro-structured surface of the MS-OCA-TT-6 in the interior of the ink-step region started after the continuous (open) air space of the micro-structured adhesive in the ink-step region changed to independent bubbles via the flowing of the MS-OCA-TT-6. In this case, due to the seal cause by the OCA in the ink step region, a large air bubble existed in the interior of the ink step region, prior to autoclave procedure. The lamination performance after the autoclave treatment was visually observed with observations noted in Table 4.

### Comparative Example F

NMS-OCA-TT-C was laminated between two glass panels; one of the glass panels had an ink step, i.e. topography, as described in Example 5. NMS-OCA-TT-C was laminated following the procedure of Example 5, with NMS-OCA-TT-C replacing MS-OCA-TT-4. RL1 was removed for lamination to the flat glass plate and RL2 was removed for lamination to the glass plate with ink-step. In this comparative example, the contact and wetting of the NMS-OCA-TT-C adhesive in the interior of the ink-step region did not occur even after the NMS-OCA-TT-C adhesive in the ink-step region had completely wetted the ink step region. In this case, due to the seal cause by the OCA in the ink step region, a large air space existed in the interior of the ink step region, prior to autoclave procedure. The lamination performance after the autoclave treatment was visually observed with observations noted in Table 4.

### Comparative Example G

NMS-OCA-TT-D was laminated between two glass panels; one of the glass panels had an ink step, i.e. topography, as described in Example 5. NMS-OCA-TT-D was laminated following the procedure of Example 5, with NMS-OCA-TT-D replacing MS-OCA-TT-4. RL1 was removed for lamination to the flat glass plate and RL2 was removed for lamination to the glass plate with ink-step. In this comparative example, the contact and wetting of the NMS-OCA-TT-D adhesive in the interior of the ink-step region did not occur even after the NMS-OCA-TT-D adhesive in the ink-step region had completely wetted the ink step region. In this case, due to the seal cause by the OCA in the ink step region, a large air space existed in the interior of the ink step region, prior to autoclave procedure. The lamination performance after the autoclave treatment was visually observed with observations noted in Table 4.

TABLE 4

| Example | Lamination Performance |
|---|---|
| Example 5 | No air bubbles. |
| Example 6 | No air bubbles. |
| Comparative Example E | Air bubbles remained. |
| Comparative Example F | Air bubbles remained. |
| Comparative Example G | Air bubbles remained. |

Although the present invention has been described with reference to preferred embodiments, workers skilled in the art will recognize that changes may be made in form and detail without departing from the spirit and scope of the invention.

1. An optically clear adhesive comprising:
a first major surface and a second major surface;
wherein at least one of the first and second major surfaces comprises a micro-structured surface of interconnected micro-structures in at least one planar (x-y) dimension;
wherein the optically clear adhesive has a tan delta value of at least about 0.3 at a lamination temperature; and
wherein the optically clear adhesive is non-crosslinked or lightly crosslinked.

2. The optically clear adhesive of claim 1, wherein the micro-structured surface comprises interconnected features in at least two planar dimensions.

3. The optically clear adhesive of claim 1, wherein the micro-structured surface comprises indentations having a depth of between about 5 and about 80 microns.

4. The optically clear adhesive of claim 1, wherein both the first and second major surfaces comprise a micro-structured surface.

5. The optically clear adhesive of claim 1, wherein the micro-structured surface comprises indentations and protrusions.

6. The optically clear adhesive of claim 1, wherein the optically clear adhesive is one of a hot-melt optically clear adhesive, a solvent coated optically clear adhesive, an on-web polymerized optically clear adhesive and a heat-activated adhesive.

7. A method of laminating a first substrate and a second substrate without the use of a vacuum, the method comprising:
providing a micro-structured optically clear adhesive comprising a first major surface and a second major surface, wherein at least one major surface comprises a micro-structured surface, wherein the micro-structured optically clear adhesive has a tan delta value of at least about 0.3 at a lamination temperature;
removing a release liner from the first major surface of the micro-structured optically clear adhesive;
contacting the first major surface of the micro-structured optically clear adhesive with a surface of the first substrate;
removing a micro-structured release liner from the second major surface of the micro-structured optically clear adhesive to expose a micro-structured surface, wherein the micro-structured surface comprises interconnected micro-structures in at least one planar dimension; and
contacting the micro-structured surface with a surface of the second substrate.

8. The method of claim 7, further comprising subjecting the laminate to at least one of heat and pressure.

9. The method of claim 7, wherein the optically clear adhesive has a tan value of at least about 0.5 at the lamination temperature.

10. The method of claim 7, wherein the micro-structured surface comprises interconnected features in at least two dimensions.

11. The method of claim 7, wherein the micro-structured surface comprises indentations having a depth of between about 5 and about 80 microns.

12. The method of claim 7, wherein both the first and second major surfaces comprise a micro-structured surface.

13. The method of claim 7, wherein the micro-structured surface comprises indentations and protrusions.

14. (canceled)

15. (canceled)

16. (canceled)

17. The method of claim 7, wherein at least one of the first and second substrates comprises a topographical feature.

18. A method of vacuumless lamination of a first substrate and a second substrate, the method comprising:
providing a micro-structured optically clear adhesive comprising a first major surface and a second major surface, wherein at least one major surface comprises a micro-structured surface, wherein the micro-structured optically clear adhesive has a tan delta value of at least about 0.3 at a temperature of between about 20° C. and about 60° C.;
contacting a surface of a micro-structured optically clear adhesive with a surface of the first substrate;
applying the micro-structured surface of the micro-structured optically clear adhesive with a surface of the second substrate to form a bond line, wherein the micro-structured surface comprises interconnected micro-structures in at least one planar dimension;
allowing point-to-point contact between the micro-structured surface and the surface of the second substrate;
uniformly spreading the micro-structured optically clear adhesive along the surface of the second substrate;
filling in continuous, open air space to substantially remove air from the bond line to form a laminate.

19. The method of claim 18, wherein the optically clear adhesive is non-crosslinked or lightly crosslinked.

20. The method of claim 18, further comprising subjecting the laminate to one of pressure and heat.

21. (canceled)

22. (canceled)

23. The method of claim 18, wherein the micro-structured surface comprises indentations having a depth of between about 5 and about 80 microns.

24. The method of claim 18, wherein both the first and second major surfaces comprise a micro-structured surface.

25. The method of claim 18, wherein at least one of the first and second substrates comprises a topographical feature.
